(19) United States
(12) Patent Application Publication
(10) Pub. No.: US 2024/0297684 A1
(43) Pub. Date: Sep. 5, 2024

(54) MULTI-FUNCTIONAL RECONFIGURABLE INTELLIGENCE SURFACE INTEGRATING SIGNAL REFLECTION, REFRACTION AND AMPLIFICATION AND ENERGY HARVESTING AND APPLICATION THEREOF

(71) Applicant: Beijing University of Posts and Telecommunications, Beijing (CN)

(72) Inventors: Hui TIAN, Beijing (CN); Wen WANG, Beijing (CN); Ping ZHANG, Beijing (CN); Gaofeng NIE, Beijing (CN); Xue RONG, Beijing (CN); Wanli NI, Beijing (CN)

(73) Assignee: Beijing University of Posts and Telecommunications, Beijing (CN)

(21) Appl. No.: 18/387,063

(22) Filed: Nov. 6, 2023

(30) Foreign Application Priority Data
Feb. 22, 2023 (CN) 202310149565.5

(51) Int. Cl. H04B 7/04; H04B 7/0426

(52) U.S. Cl. CPC H04B 7/04013; H04B 7/043

(57) ABSTRACT

A multi-functional reconfigurable intelligence surface (MF-RIS) integrating signal reflection, refraction and amplification and energy harvesting and an application thereof are provided. The MF-RIS can support wireless signal reflection, refraction and amplification and energy harvesting on one surface, to amplify, reflect, or refract a signal through harvested energy, and further enhance effective coverage of wireless signals. When a signal model of the MF-RIS constructed in the present disclosure is applied to a multi-user wireless network, a non-convex optimization problem of jointly designing operation modes and parameters that include BS transmit beamforming, and different components and a deployment position of the MF-RIS is constructed with an objective of maximizing a sum rate (SR) of a plurality of users in an MF-RIS-assisted non-orthogonal multiple access network. Then, an iterative optimization algorithm is designed to effectively solve the non-convex optimization problem, to maximize the SR of the plurality of users.

### CROSS REFERENCE TO THE RELATED APPLICATIONS

This application is based upon and claims priority to Chinese Patent Application No. 202310149565.5, filed on Feb. 22, 2023, the entire contents of which are incorporated herein by reference.

### TECHNICAL FIELD

The present disclosure relates to the technical field of wireless resource allocation, and in particular, to a modeling and optimization method for a multi-functional reconfigurable intelligence surface (MF-RIS) integrating signal reflection, refraction and amplification and energy harvesting.

### BACKGROUND

A reconfigurable intelligence surface (RIS) or an intelligence reconfigurable surface (IRS) has become a potential development direction of future communication networks due to its advantages of improving energy efficiency and spectrum efficiency in a cost-effective manner. The RIS can establish a tunable communication environment by modifying a phase shift or an amplitude of an incident signal, to achieve various communication goals, such as improving throughput, enhancing security, and reducing transmission energy consumption. However, due to a hardware limitation, a traditional reflection-based single-functional RIS (SF-RIS) can achieve only half-space signal coverage. This greatly limits deployment flexibility and effectiveness of the RIS in a wireless network in which users are randomly distributed.

To overcome this limitation, dual-functional RIS (DF-RIS) structures, such as a simultaneous transmitting and reflecting RIS (STAR-RIS) and an intelligent omni-surface (IOS), have been proposed. The DF-RIS achieves full-space signal coverage by supporting both signal reflection and refraction, and creates a ubiquitous intelligent radio environment. However, both SF-RIS and DF-RIS-assisted communication links have a double fading phenomenon, and signal reception is seriously damaged.

To resolve the double fading phenomenon faced by an existing passive RIS, an active RIS structure is proposed. The active RIS achieves significant spectrum efficiency gains by embedding a power amplifier into the traditional SF-RIS and properly designing a phase shift and an amplification factor. In addition, there is another metasurface structure that supports signal amplification: a dynamic metasurface antenna (DMA). The DMA overcomes the serious path loss problem of the passive RIS by amplifying and phase-shifting an incident signal to different degrees, so as to implement an active large-scale antenna array. However, both the active RIS and the DMA require additional power consumption to maintain the operation of an active element. Consequently, performance implementation highly depends on an external power supply.

The foregoing RIS structures are all powered by batteries or a power grid. For a battery-powered RIS, an embedded battery provides only a limited lifetime and cannot support long-term operation of the RIS. Considering environmental hazards and hardware limitations, manual replacement of the battery of the RIS is costly and impractical. In addition, because power line networks are inaccessible in mountainous areas or the like, there are limited positions at which a grid-powered RIS can be deployed. Therefore, the present disclosure aims to develop a new RIS structure that achieves self-sustainability while maintaining the performance advantages of the RIS.

### SUMMARY

In view of a fact that performance implementation of an existing RIS structure highly depends on an external power supply, the present disclosure provides an MF-RIS integrating signal reflection, refraction and amplification and energy harvesting. An incident signal can be reflected, transmitted, and amplified through energy harvested from a radio frequency (RF) signal. Therefore, the provided MF-RIS can not only maintain energy self-sufficiency, but also achieve full-space signal coverage and effectively reduce a path loss. All elements are capable of being flexibly switched between different working modes such that the MF-RIS provides more freedom for signal processing.

To achieve the foregoing objective, the present disclosure provides the following technical solutions:

According to one aspect, the present disclosure provides an MF-RIS integrating signal reflection, refraction and amplification and energy harvesting, having two working modes: an energy harvesting mode and a signal relay mode. In the signal relay mode, an incident signal is reflected and refracted through surface equivalent electrical impedance and magnetoimpedance elements. The incident signal is divided into two parts by controlling electric current and magnetic current through a microcontroller unit (MCU) chip. One part is reflected to reflection half-space and the other part is refracted to refraction half-space. A reflected signal and a refracted signal are amplified through an amplifier circuit. In the energy harvesting mode, RF energy is obtained from the incident signal and converted into direct current (DC) power through an impedance matcher, an RF-DC conversion circuit and a capacitor, and an energy management module controls energy to be stored in an energy storage apparatus or supplied for operation of a phase shifter and the amplifier circuit. A circuit connection is adjusted such that each element is capable of being flexibly switched between the energy harvesting mode and the signal relay mode.

According to another aspect, the present disclosure further provides application of the foregoing MF-RIS integrating signal reflection, refraction and amplification and energy harvesting in a multi-user wireless network, including the following steps:
S1: designing operation modes and parameters, including base station (BS) transmit beamforming, and different components and a deployment position of the MF-RIS, and constructing a mixed integer non-linear programming non-convex optimization problem and constraints with an objective of maximizing an achievable sum rate (SR) of all users;
S2: decomposing the non-convex problem constructed in S1 into three subproblems: a BS transmit beamforming optimization problem, an MF-RIS coefficient design problem, and an MF-RIS deployment optimization problem; and
S3: performing alternating optimization (AO) on the subproblems obtained through decomposition in S2 to ensure that each sub-algorithm converges to a local optimum, which specifically includes: for the BS transmit beamforming optimization problem, introducing auxiliary variables and solving the BS transmit beamforming optimization problem through a sequential rank-one constraint relaxation (SROCR) method; for the MF-RIS coefficient design problem, introducing an auxiliary variable, replacing a non-convex objective function with its convex upper bound (CUB), processing an equality constraint through a penalty function method, and designing a coefficient of the MF-RIS; and for the MF-RIS deployment optimization problem, designing the position of the MF-RIS through a local area optimization method, and processing a non-convex term through successive convex approximation (SCA) to transform the MF-RIS deployment optimization problem into a solvable convex problem.

Further, the optimization problem and the constraints in S1 are as follows:

$${max}_{{f}_{k} , {Θ}_{k} , w} {\sum }_{k} {\sum }_{j ∈ {J}_{k}} {R}_{j \to j}^{k}$$

$$s . t . {\sum }_{k} {‖ {f}_{k} ‖}^{2} \leq {P}_{BS}^{ma x} ,$$

$${Θ}_{k} ∈ {R}_{mf} , ∀ k ∈ K ,$$

$${R}_{j \to j}^{k} \geq {R}_{kj}^{m i n} , ∀ k ∈ K , ∀ j ∈ {J}_{k} ,$$

$$w ∈ P = \{ {[ x , y , z ]}^{T} \vert {x}_{m i n} \leq x \leq {x}_{m a x} , {y}_{m i n} \leq y \leq {y}_{m ax} , {z}_{m i n} \leq z \leq {z}_{m a x} \} ,$$

$$\frac{{\vert {\overline{h}}_{kj} {f}_{k} \vert}^{2}}{{\vert {\overline{h}}_{kj} {f}_{\overline{k}} \vert}^{2} + {\vert {g}_{kj}^{H} {Θ}_{k} {n}_{s} \vert}^{2} + {σ}_{u}^{2}} \leq \frac{{\vert {\overline{h}}_{kl} {f}_{k} \vert}^{2}}{{\vert {\overline{h}}_{kl} {f}_{\overline{k}} \vert}^{2} + {\vert {g}_{kl}^{H} {Θ}_{k} {n}_{s} \vert}^{2} + {σ}_{u}^{2}} , ∀ k ∈ K , ∀ j ∈ {J}_{k} , ∀ l ∈ {L}_{k} ,$$

$${R}_{l \to j}^{k} \geq {R}_{j \to j}^{k} , ∀ k ∈ K , ∀ j ∈ {J}_{k} , ∀ l ∈ {L}_{k}$$

$$2 ( {P}_{b} {P}_{D C} ) {\sum }_{m} {α}_{m} ( M - {\sum }_{m} {α}_{m} ) {P}_{C} + ξ {P}_{O} \leq {\sum }_{m} {P}_{m}^{A} ,$$

where a quantity of elements of the MF-RIS is M, a set of the elements of the MF-RIS is indexed as M={1, . . . , M}, and m is an m^{th} element in the set of the elements; a quantity of antennas is J, a space set is K={r,t}, a user set is J={1, 2, . . . , J}, j is a j^{th} element in the user set, Jₖ={1, 2, . . . , Jₖ)} represents a user set in space K, Jᵣ∪Jₜ=J, and if k=t, k̅=r; if k=r, k̅=t, and a user j in the space K is indexed as Uₖⱼ; h̅ₖⱼ=hₖⱼ^{H}+gₖⱼ^{H}ΘₖH represents a combined channel vector from a BS to the user Uₖⱼ, Θₖ is the coefficient of the MF-RIS, and R_{MF} is a feasible coefficient set of the MF-RIS; R_{j→j}^{k} is an achievable rate of an expected signal of the user Uₖⱼ, Rₖⱼ^{min} represents a minimum quality of service requirement of the user Uₖⱼ, fₖ is a transmit beamforming vector of the space k, P_{BS}^{max} represents maximum transmit power of the BS, P represents a predefined deployment area of the MF-RIS, considering a three-dimensional (3D) Cartesian coordinate system, positions of the BS, the MF-RIS, and the user Uₖⱼ are respectively w_{b}=[x_{b}, y_{b}, z_{b}]^{T}, w=[x, y, z]^{T}, and wₖⱼ=[xₖⱼ, yₖⱼ, 0]^{T}, and [xₘᵢₙ, xₘₐₓ], [yₘᵢₙ, yₘₐₓ], and [zₘᵢₙ, zₘₐₓ] respectively represent candidate ranges along X, Y, and Z axes; nₛ˜CN (0,σₛ²I_{M}) represents amplified noise introduced at the MF-RIS with noise power σₛ² per unit, and nₖⱼ˜CN (0,σᵤ²) represents additive white Gaussian noise (AWGN) at the user Uₖⱼ with power σᵤ²; a constant aₘ represents impact of a circuit sensitivity limitation on the m^{th} element, and P_{b}, P_{DC}, P_{C} respectively represent power consumed by each phase shifter, DC bias power consumed by the amplifier circuit, and power consumed by the RF-DC conversion circuit; and ξ is a reciprocal of an energy conversion coefficient, and P_{O}=Σₖ(∥ΘₖHΣₖfₖ∥²+σₛ²∥ΘₖI_{M}∥²) represents output power of the MF-RIS.

Further, decomposing the non-convex problem into the three subproblems in S2 includes:
removing the constraint R_{l→j}^{k}≥R_{j→j}^{k}, ∀k∈K, ∀j∈Jₖ, ∀I∈Lₖ, from the non-convex problem;
introducing a relaxation variable set Δ₀={Aₖⱼ, Bₖⱼ, Γₖⱼ, Cₘ, ζₘ} such that:

$${A}_{kj}^{- 1} = {\vert {\overline{h}}_{kj} {f}_{k} \vert}^{2} , {B}_{kj} = {\vert {\overline{h}}_{kj} {f}_{\overline{k}} \vert}^{2} + {\vert {g}_{kj}^{H} {Θ}_{k} {n}_{s} \vert}^{2} + {σ}_{u}^{2} ,$$

$${Γ}_{kj} = {A}_{kj}^{- 1} {B}_{kj}^{- 1} ,$$

$${\sum }_{m} {C}_{m}^{- 1} = ( W + ξ {P}_{O} ) ( 1 - Ω ) {Z}^{- 1} + M Ω ,$$

$${ζ}_{m} = {P}_{m}^{RF}$$

rewriting the constraints as:

$${A}_{kj}^{- 1} \leq {\vert {\overline{h}}_{kj} {f}_{k} \vert}^{2} , {B}_{kj} \geq {\vert {\overline{h}}_{kj} {f}_{\overline{k}} \vert}^{2} + {\vert {g}_{kj}^{H} {Θ}_{k} {n}_{s} \vert}^{2} + {σ}_{u}^{2} , {Γ}_{kj} \geq {A}_{kj}^{- 1} {B}_{kj}^{- 1} , ∀ k ∈ K , ∀ j ∈ {J}_{k} ,$$

$${Γ}_{kj} \leq {A}_{kl}^{- 1} {B}_{kl}^{- 1} , ∀ k ∈ K , ∀ j ∈ {J}_{k} , ∀ l ∈ {L}_{k} , ( W + ξ {P}_{O} ) ( 1 - Ω ) {Z}^{- 1} + M Ω \leq {\sum }_{m} {C}_{m}^{- 1} ,$$

$${ζ}_{m} \leq {P}_{m}^{RF} , {C}_{m} \geq exp ( - a ( {ζ}_{m} - q ) ) + 1 , ∀ m ,$$

$$where W = 2 ( {P}_{b} + {P}_{D C} ) {\sum }_{m} {α}_{m} + ( M - {\sum }_{m} {α}_{m} ) {P}_{C} ; and$$

processing the non-convex constraints in the foregoing second formula through SCA;

and performing first-order Taylor expansion to obtain lower bounds of right-hand terms of Aₖₗ⁻¹Bₖₗ⁻¹ and ΣₘCₘ⁻¹ at feasible points {Aₖₗ^{(l)}, Bₖₗ^{(l)}, Cₘ^{(l)}} in a [symbol] ^{th} iteration as follows:

$${Γ}_{k l}^{I b} = \frac{1}{{A}_{k l}^{〈 ℓ )} {B}_{k l}^{〈 ℓ )}} - \frac{{A}_{k l} - {A}_{k l}^{〈 ℓ )}}{{( {A}_{k l}^{〈 ℓ )} )}^{2} {B}_{k l}^{〈 ℓ )}} - \frac{{B}_{k l} - {B}_{k l}^{〈 ℓ )}}{{( {B}_{k l}^{〈 ℓ )} )}^{2} {A}_{k l}^{〈 ℓ )}} , {C}^{Ib} = {\sum }_{m} ( \frac{2}{{C}_{m}^{( ℓ )}} - \frac{{C}_{m}}{{( {C}_{m}^{( ℓ )} )}^{2}} )$$

In this way, the non-convex problem is decomposed into the three subproblems: the BS transmits beamforming optimization problem, the MF-RIS coefficient design problem, and the MF-RIS deployment optimization problem.

Further, in S3, for the BS transmit beamforming optimization problem, given {Θₖ, w}, auxiliary variables Qₖⱼ and Cₖⱼ are introduced to transform an objective function

$${max}_{{f}_{k} , {Θ}_{k} , w} {\sum }_{k} {\sum }_{j ∈ {J}_{k}} {R}_{j \to j}^{k} , {Q}_{kj} = {R}_{j \to j}^{k} and {C}_{kj} = {\vert {\overline{h}}_{kj} {f}_{k} \vert}^{2} {P}_{kj} + {B}_{kj} ,$$

a non-convex constraint Qₖⱼ≤log₂(1+pₖⱼAₖⱼ⁻¹Cₖⱼ⁻¹) is processed through SCA, a lower bound of a right-hand term of the non-convex constraint is obtained in the [symbol] ^{th} iteration, H̅ₖⱼ= [symbol] and Fₖ=kₖfₖ^{H} are defined, Fₖ±0 and rank(Fₖ)=1, an auxiliary variable set Δ₁={Aₖⱼ, Bₖⱼ, Cₖⱼ, Qₖⱼ, Γₖⱼ, Cₘ, ζₘ} and

$$\overline{W} = \frac{( {C}^{Ib} - MΩ ) Z}{( 1 - Ω ) ξ} - \frac{w}{ξ}$$

are introduced such that W̅≥Σₖ Tr(Θₖ(H(Σₖ Fₖ)H^{H}+σₛ²I_{M})Θₖ^{H}), a rank-one constraint rank(Fₖ)=1, ∀k is replaced by a linear constraint (fₖ^{e,(} [symbol] ⁻¹⁾)^{H}Fₖ⁽ [symbol] ⁾fₖ^{e,(} [symbol] ⁻¹⁾≥wₖ⁽ [symbol] ⁻¹⁾Tr(Fₖ⁽ [symbol] ⁾), ∀k, through the SROCR method, wₖ⁽ [symbol] ⁻¹⁾∈[0, 1] is a trace ratio parameter of Fₖ in a ( [symbol] −1)^{th} iteration, fₖ^{e,(} [symbol] ⁻¹⁾ is an eigenvector corresponding to a maximum eigenvalue of Fₖ^{(l-1)}, Fₖ^{(l-1)} is a solution of wₖ⁽ [symbol] ⁻¹⁾ in the ( [symbol] −1)^{th} iteration, and the BS transmit beamforming optimization problem is transformed into a convex semidefinite programming (SDP) problem.

Further, an algorithm for solving the convex SDP problem into which the BS transmit beamforming optimization problem is transformed includes: initializing feasible points {Fₖ⁽⁰⁾, wₖ⁽⁰⁾} and a step δ₁⁽⁰⁾, setting an iteration index [symbol] ₁=0, and repeating the following steps until a stop criterion is satisfied: if the convex SDP problem is solvable, solving the convex SDP problem to update Fₖ⁽ [symbol] ^{₁}⁺¹⁾, and updating δ₁⁽ [symbol] ^{₁}⁺¹⁾=δ₁⁽ [symbol] ^{₁}⁾; otherwise, updating

$${δ}_{1}^{( {ℓ}_{1} + 1 )} = \frac{{δ}_{1}^{( {ℓ}_{1} )}}{2} ;$$

and updating

$${w}_{k}^{( {ℓ}_{1} + 1 )} = min ( 1 , \frac{{λ}_{ma x} ( {F}_{k}^{( {ℓ}_{1} + 1 )} )}{T r ( {F}_{k}^{( {ℓ}_{1} + 1 )} )} + {δ}_{1}^{( {ℓ}_{1} + 1 )} )$$

and [symbol] ₁= [symbol] ₁+1, and ending the current iteration.

Further, in S3, for the MF-RIS coefficient design problem, given {fₖ, w}, Hₖⱼ=[diag(gₖⱼ^{H})], vₖ=[α₁\sqrt{β₁^{k}} e^{jθ}^{₁}^{^{k}}, α₂\sqrt{β₂^{k}} e^{jθ}^{₂}^{^{k}}, . . . , α_{M}\sqrt{β_{M}^{k}} e^{jθ}^{_{M}}^{^{k}}]^{H}, and uₖ=[vₖ; 1] are defined; and Uₖ=uₖuₖ^{H} is defined, Uₖ±0, rank(Uₖ)=1, [U]_{m,m}=αₘ²βₘ^{k}, [Uₖ]_{M+1, M+1}=1, and the following equation is obtained:

$${{\vert {\overline{h}}_{kj} {f}_{kj} \vert}^{2} = \vert {h}_{kj}^{H} + {g}_{kj}^{H} {Θ}_{k} H ) {f}_{k} \vert}^{2} = Tr ( {H}_{kj} {F}_{k} {H}_{kj}^{H} {U}_{k} )$$

Similarly, |gₖⱼ^{H}Θₖnₛ|²=Tr(GₖⱼUₖ) and P_{O}=Σₖ Tr(HUₖ) are obtained.

The constraints on Aₖⱼ, Bₖⱼ, Cₖⱼ, W̅ are rewritten as:

$${A}_{{k}_{J}}^{- 1} \leq T r ( {\tilde{H}}_{kj} {F}_{k} {\tilde{H}}_{kj}^{H} {U}_{k} ) , {B}_{kj} \geq T r ( ( {\tilde{H}}_{kj} {F}_{\overline{k}} {\tilde{H}}_{kj}^{H} + {\tilde{G}}_{kj} ) {U}_{k} ) + {σ}_{u}^{2} ,$$

$${C}_{kj} \geq Tr ( {\tilde{H}}_{kj} {F}_{k} {\tilde{H}}_{kj}^{H} {U}_{k} ) {P}_{kj} + {B}_{kj} , \overline{W} \geq {\sum }_{k} T r ( \tilde{H} {U}_{k} )$$

A rank-one constraint rank(Uₖ)=1, ∀k is approximated as (uₖ^{eig,(} [symbol] ⁻¹⁾)^{H} Uₖ⁽ [symbol] ⁾uₖ^{eig,(} [symbol] ⁻¹⁾≥νₖ⁽ [symbol] ⁻¹⁾Tr(Uₖ⁽ [symbol] ⁾), ∀k. A binary constraint αₘ∈{0, 1}, ∀m is equivalently transformed into αₘ−αₘ²≤0, 0≤αₘ≤1.

The constraint αₘ−αₘ²≤0 is processed through SCA. An auxiliary variable ηₘ^{k}=αₘ²βₘ^{k} is introduced, and a non-convex constraint [Uₖ]_{m,m}=αₘ²βₘ^{k}, ∀m,k is equivalently represented as [Uₖ]_{m,m}=ηₘ^{k}, ηₘ^{k}=αₘ²βₘ^{k}. The equality constraint ηₘ^{k}=αₘ²βₘ^{k} is processed through a penalty function to transform the MF-RIS coefficient design problem into a penalty function method-based problem.

Further, an algorithm for solving the penalty function method-based problem includes: initializing feasible points {Uₖ⁽⁰⁾, σₖ⁽⁰⁾}, ε>1, and a step δ₂⁽⁰⁾, and setting an iteration index [symbol] ₂=0 and a maximum value of a penalty factor ρₘₐₓ; and repeating the following steps: if [symbol] ₂≤ [symbol] ₂^{max} and the problem is solvable, solving the problem to update [symbol] , and updating [symbol] = [symbol] ; otherwise, updating

$${δ}_{2}^{( {ℓ}_{2} + 1 )} = \frac{{δ}_{2}^{( {ℓ}_{2} )}}{2} ;$$

updating

$${v}_{k}^{( {ℓ}_{2} + 1 )} = min ( 1 , \frac{{λ}_{ma x} ( {U}_{k}^{( {ℓ}_{2} + 1 )} )}{T r ( {U}_{k}^{( {ℓ}_{2} + 1 )} )} + {δ}_{2}^{( {ℓ}_{2} + 1 )} ) ;$$

and if [symbol] =min{ε [symbol] , ρₘₐₓ}, updating [symbol] ₂= [symbol] ₂+1 and ending the current iteration; otherwise, reinitializing Uₖ⁽⁰⁾ and letting ε>1 and [symbol] ₂=0 until a stop criterion is satisfied.

Further, in S3, for the MF-RIS deployment optimization problem, the position w of the MF-RIS is designed through the local area optimization method. w⁽ⁱ⁻¹⁾ is defined as a position of the MF-RIS obtained in an (i−1)^{th} iteration. A position variable satisfies a constraint ∥w−w⁽ⁱ⁻¹⁾∥≤ò. It is assumed that Ĥ⁽ⁱ⁻¹⁾ and ĝₖⱼ⁽ⁱ⁻¹⁾ are obtained in the (i−1)^{th} iteration. Ĥ⁽ⁱ⁻¹⁾ and ĝₖⱼ⁽ⁱ⁻¹⁾ are respectively an array response and small-scale fading after the (i−1)^{th} iteration from the BS to the MF-RIS and from the MF-RIS to the user Uₖⱼ. A constraint including Aₖⱼ, Bₖⱼ, Cₖⱼ, d_{bs}^{κ}^{_{bs}}, d_{bs}^{κ}^{_{bs}} is re-expressed. An auxiliary variable set is introduced to replace complex terms of the constraint. A non-convex part of the constraint is approximated through SCA. A right-hand term of a non-convex constraint rₖⱼ≤d̅ₖⱼ^{T}ĤₖⱼFₖĤₖⱼ^{H}d̅ₖⱼ is a convex term with respect to d̅ₖⱼ^{T}. The constraint rₖⱼ≤d̅ₖⱼ^{T}ĤₖⱼFₖĤₖⱼ^{H}d̅ₖⱼ is rewritten as a convex constraint rₖⱼ≤−(d̅ₖⱼ^{(l)})^{T}ĤₖⱼFₖĤₖⱼ^{H}d̅ₖⱼ^{(l)}+2 [symbol] ((d̅ₖⱼ^{(l)})^{T}Ĥₖⱼ FₖĤₖⱼ^{H}dₖⱼ), through first-order Taylor expansion. d̅ₖⱼ⁽ [symbol] ⁾ is a feasible point in the [symbol] ^{th} iteration.

Further, an algorithm for solving the local area-based problem includes: initializing feasible points {w⁽⁰⁾, t⁽⁰⁾, tₖⱼ⁽⁰⁾, ν⁽⁰⁾} and setting an iteration index [symbol] ₃=0; and repeating the following steps: solving the problem to update { [symbol] , [symbol] , [symbol] , [symbol] } and updating [symbol] ₃= [symbol] ₃+1 until a stop criterion is satisfied.

Compared with the prior art, the present disclosure has the following beneficial effects:

The MF-RIS integrating signal reflection, refraction and amplification and energy harvesting provided in the present disclosure has various signal processing functions, and can support wireless signal reflection, transmission/refraction, and amplification and energy harvesting on one surface, to amplify, reflect, or refract a signal through harvested energy, and further enhance effective coverage of wireless signals. The MF-RIS provided in the present disclosure can not only maintain energy self-sufficiency, but also achieve full-space signal coverage and effectively reduce a path loss. All elements is capable of being flexibly switched between different working modes such that the MF-RIS provides more freedom for signal processing. Integrating a plurality of signal processing functions on one surface, the provided MF-RIS can achieve performance gains of up to 23.4% compared with a traditional passive RIS and 98.8% compared with a traditional self-sufficient RIS.

In a signal model of the MF-RIS constructed in the present disclosure, the non-convex optimization problem of jointly designing the operation modes and parameters that include BS transmit beamforming, and different components and the deployment position of the MF-RIS, is constructed with an objective of maximizing an SR of a plurality of users in an MF-RIS-assisted non-orthogonal multiple access (NOMA) network. Then, an iterative optimization algorithm is designed to effectively solve the non-convex optimization problem, to maximize the SR of the plurality of users. In addition, deploying the MF-RIS closer to a transmitter facilitates energy harvesting and can bring higher performance gains.

### BRIEF DESCRIPTION OF THE DRAWINGS

To describe the technical solutions in embodiments of the present application or in the prior art more clearly, the following briefly describes the accompanying drawings required for describing the embodiments. Apparently, the accompanying drawings in the following description show merely some embodiments of the present disclosure, and persons of ordinary skill in the art may still derive other accompanying drawings from these accompanying drawings.

FIG. 1 is a schematic implementation diagram of an MF-RIS according to an embodiment of the present disclosure; and

FIG. 2 is a flowchart of an AO algorithm according to an embodiment of the present disclosure.

### DETAILED DESCRIPTION OF THE EMBODIMENTS

To better understand the technical solutions, the foregoing describes in detail a method in the present disclosure with reference to the accompanying drawings.

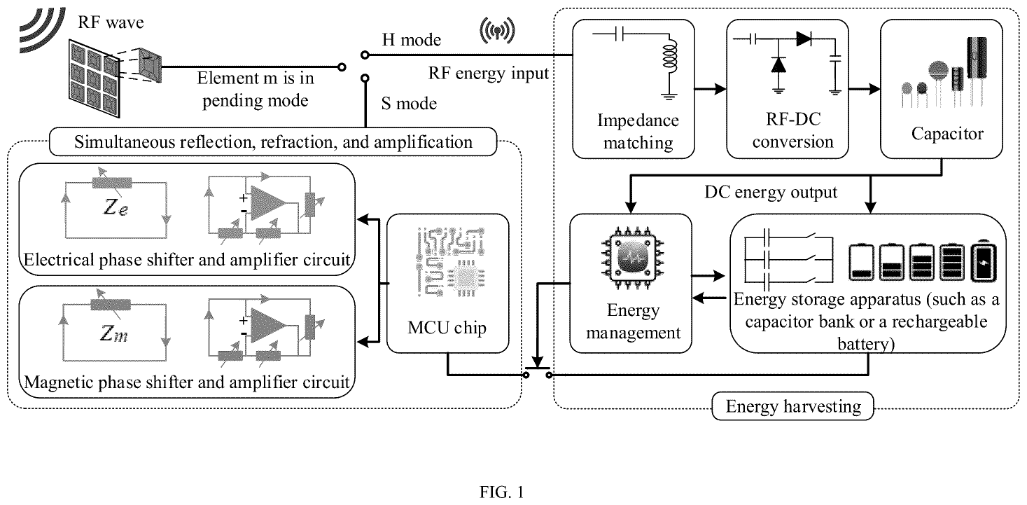

Referring to FIG. 1, the present disclosure provides an MF-RIS integrating signal reflection, refraction and amplification and energy harvesting, having two working modes: an energy harvesting mode (H mode) and a signal relay mode (S mode). In the signal relay mode, an incident signal is reflected and refracted through surface equivalent electrical impedance and magnetoimpedance elements. The incident signal is divided into two parts by controlling electric current and magnetic current through an MCU chip. One part is reflected to reflection half-space and the other part is refracted to refraction half-space. A reflected signal and a refracted signal are amplified through an amplifier circuit. In the energy harvesting mode, RF energy is obtained from the incident signal and converted into DC power through an impedance matcher, an RF-DC conversion circuit and a capacitor, and an energy management module controls energy to be stored in an energy storage apparatus or supplied for operation of a phase shifter and the amplifier circuit. A circuit connection is adjusted such that each element is capable of being flexibly switched between the energy harvesting mode and the signal relay mode. Because a switching frequency of positive and negative intrinsic diodes is up to 5 MHz, a mode switching time of the MF-RIS is negligible compared with a typical wireless channel coherence time (for example, 4.2 ms).

An energy harvesting circuit mainly relies on the following elements:

An impedance matching network composed of resonators with a high quality factor ensures maximum power transmission from an element to a rectifier block. The RF-DC conversion circuit rectifies available RF power into DC voltage. The capacitor is configured to ensure electric current is smoothly transmitted to the energy storage apparatus or used as a short-term reserve when RF energy is unavailable. The power management module decides whether to store the energy obtained through conversion or use the energy for signal reflection, transmission, and amplification. The energy storage apparatus (such as a rechargeable battery and a supercapacitor) is configured to store the energy. When harvested energy exceeds consumed energy, excess energy is stored for future use, to achieve continuous self-sufficiency.

For other elements working in the S mode, the incident signal is divided into the two parts by controlling the electric current and magnetic current. One part is reflected to the reflection half-space and the other part is refracted to the refraction half-space. With the help of the MCU, these elements can use the harvested energy to maintain the operation of the phase shifter and the amplifier circuit. Therefore, the provided MF-RIS does not require any external power supply in principle. Implementation of a reflect and transmit amplifier is also shown in FIG. 1. An operational amplifier-based electric current converter is configured to generate amplified reflect and transmit signals.

An MF-RIS structure integrating energy harvesting and signal reflection, refraction and amplification provided in the present disclosure can implement signal reflection, transmission or refraction, and amplification and energy harvesting. An implementation of the MF-RIS is also provided, and an operation protocol in an actual wireless network is designed for the MF-RIS.

Specifically, application of the MF-RIS provided in the present disclosure in a multi-user wireless network includes the following steps:

S1: A mixed integer non-linear programming non-convex problem of jointly designing operation modes and parameters that include BS transmit beamforming, and different components and a deployment position of the MF-RIS is constructed to maximize an SR of a plurality of users.

To characterize a signal model of the MF-RIS, it is considered that the MF-RIS has M elements. A set of the elements of the MF-RIS is indexed as M={1, . . . , M}. sₘ represents a signal received by the m^{th} element. Due to hardware limitations, it is considered that each element cannot simultaneously work in both the H and S modes. Therefore, signals harvested, reflected, and refracted by the m^{th} element are modeled as follows:

$${y}_{m}^{h} = ( 1 - {α}_{m} ) {s}_{m} , {y}_{m}^{r} = {α}_{m} \sqrt{{β}_{m}} {e}^{j {θ}_{m}} {s}_{m} , {y}_{m}^{t} = {α}_{m} \sqrt{{β}_{m}} {e}^{j {θ}_{m}} {s}_{m}$$

αₘ={0, 1}, θₘ^{r}, θₘ^{t}∈[0, 2π), βₘ^{r}, βₘ^{t}∈[0, βₘₐₓ] respectively represent an energy harvesting coefficient, and reflection and refraction phase shifts and their corresponding amplitudes. αₘ=1 represents that the m^{th} element works in the S mode, and αₘ=0 represents that the element works in the H mode. βₘₐₓ≥1 represents an amplification factor. According to a law of conservation of energy, the amplifier should not consume more energy than maximum available energy that can be provided by the MF-RIS, that is, βₘ^{r}+Bₘ^{t}≤βₘₐₓ. Reflection and refraction coefficients of the MF-RIS are modeled as follows:

$${Θ}_{r} = diag ( {α}_{1} \sqrt{{β}_{1}^{r}} {e}^{j {θ}_{1}^{r}} , {α}_{2} \sqrt{{β}_{2}^{r}} {e}^{j {θ}_{2}^{r}} , … , {α}_{M} \sqrt{{β}_{M}^{r}} {e}^{j {θ}_{M}^{r}} )$$

$${Θ}_{t} = diag ( {α}_{1} \sqrt{{β}_{1}^{t}} {e}^{j {θ}_{1}^{t}} , {α}_{2} \sqrt{{β}_{2}^{t}} {e}^{j {θ}_{2}^{t}} , … , {α}_{M} \sqrt{{β}_{M}^{t}} {e}^{j {θ}_{M}^{t}} )$$

$${α}_{m} ∈ \{ 0 , 1 \} , {β}_{m}^{r} , {β}_{m}^{t} ∈ [ 0 , {β}_{m ax} ] , {β}_{m}^{r} + {β}_{m}^{t} \leq {β}_{m ax} , {θ}_{m}^{r} , {θ}_{m}^{t} ∈ [ 0 , 2 π )$$

An MF-RIS-assisted downlink NOMA network is considered. An N-antenna BS serves J single-antenna users with the help of an MF-RIS composed of M units. r(t) represents reflection (refraction) space. K={r,t} represents a space set, and J={1, 2, . . . , J} represents a user set. Jₖ={1, 2, . . . , Kₖ)} represents a user set in space K. Jᵣ∪Jₜ=J. For symbol simplicity, a user J in the space K is indexed as Uₖⱼ.

Considering a 3D Cartesian coordinate system, positions of the BS, the MF-RIS, and the user Uₖⱼ are respectively w_{b}=[x_{b}, y_{b}, z_{b}]^{T}, w=[x, y, z]^{T}, and wₖⱼ=[xₖⱼ, yₖⱼ, 0]^{T}. Due to limited coverage of the MF-RIS, its deployable area is also limited. P represents a predefined deployment area of the MF-RIS, and the following constraint should be satisfied:

$$w ∈ P = \{ {[ x , {y}_{r} z ]}^{T} \vert {x}_{m i n} \leq x \leq {x}_{ma x} , {y}_{m i n} \leq y \leq {y}_{m a x} , {z}_{m i n} \leq z \leq {z}_{m a x} \} ,$$

[xₘᵢₙ, xₘₐₓ], [yₘᵢₙ, yₘₐₓ], and [zₘᵢₙ, zₘₐₓ] respectively represent candidate ranges along X, Y, and Z axes.

To characterize maximum performance that the MF-RIS can achieve, perfect channel state information for all channels is assumed to be available. Ricean fading modeling is performed for all channels. For example, a channel matrix H∈ [symbol] ^{M×N} between the BS and the MF-RIS is as follows:

$$H = {\underbrace{\sqrt{{h}_{0} {d}_{bs}^{- {κ}_{bs}}}}}_{{L}_{bs}} {\underbrace{( \sqrt{\frac{{β}_{bs}}{{β}_{bs} + 1}} {H}^{LoS} + \sqrt{\frac{1}{{β}_{bs} + 1}} {H}^{NLoS} )}}_{\hat{H}} ,$$

L_{bs} is a distance-dependent path loss. Ĥ constitutes an array response and small scale fading. Specifically, h₀ is a path loss at a reference distance of 1 meter, d_{bs} is a link distance between the BS and the MF-RIS, and κ_{bs} is a corresponding path loss index. For small-scale fading, β_{bs} is a Ricean factor, and H^{NLoS} is a non-line-of-sight (NLOS) component that follows independent and identically distributed Rayleigh fading. It is assumed that the MF-RIS is parallel to a Y-Z plane. The M elements of the MF-RIS form an uniform rectangular array M_{y}×M_{z}=M. A line-of-sight (LOS) component H^{LoS} is expressed as follows:

$${H}^{LoS} = {[ 1 , {e}^{- j \frac{2 π}{λ} dsin {φ}_{r} si n {ϑ}_{r}} , … , {e}^{- j \frac{2 π}{λ} ( {M}_{z} - 1 ) dsin {φ}_{r} s i n {ϑ}_{r}} ]}^{T}$$

$$⊗ {[ 1 , {e}^{- j \frac{2 π}{λ} d co s {φ}_{r} s i n {ϑ}_{r}} , … , {e}^{- j \frac{2 π}{λ} ( {M}_{y} - 1 ) d co s {φ}_{r} s i n {ϑ}_{r}} ]}^{T}$$

$$⊗ [ 1 , {e}^{- j \frac{2 π}{λ} d si n {φ}_{r} c o s {ϑ}_{r}} , … , {e}^{- j \frac{2 π}{λ} ( N - 1 ) d si n {φ}_{r} co s {ϑ}_{r}} ] ,$$

An operator ⊗ represents a Kronecker product, À is a carrier wavelength, and d is an antenna distance. φ^{r}, ϑᵣ, φ^{t}, and ϑₜ respectively represent vertical and horizontal angles of arrival, and vertical and horizontal angles of departure. A channel vector hₖⱼ^{H}∈ [symbol] _{1×N} from the BS to the user Uₖⱼ and a channel vector gₖⱼ^{H}∈ [symbol] ^{1×M} from the MF-RIS to the user Uₖⱼ can be obtained through a procedure similar to that for obtaining H, and are as follows:

$${h}_{kj} = {\underbrace{\sqrt{{h}_{0} {d}_{bkj}^{- {κ}_{bkj}}}}}_{{L}_{bkj}} {\underbrace{( \sqrt{\frac{{β}_{bkj}}{{β}_{bkj} + 1}} {h}_{bkj}^{LoS} + \sqrt{\frac{1}{{β}_{bkj} + 1}} {h}_{bkj}^{NLoS} )}}_{{\hat{h}}_{kj}} ,$$

$${g}_{kj} = {\underbrace{\sqrt{{h}_{0} {d}_{skj}^{- {κ}_{skj}}}}}_{{L}_{skj}} {\underbrace{( \sqrt{\frac{{β}_{skj}}{{β}_{skj} + 1}} {g}_{kj}^{LoS} + \sqrt{\frac{1}{{β}_{skj} + 1}} {g}_{kj}^{NLoS} )}}_{{\hat{g}}_{kj}}$$

To facilitate NOMA transmission, the BS transmits a superposed signal through a plurality of beamforming vectors, that is,

$$s = {\sum }_{k} {f}_{k} {\sum }_{j ∈ {J}_{k}} \sqrt{{p}_{kj} {s}_{kj}} .$$

fₖ is a transmit beamforming vector of the space k. pₖⱼ is a power allocation factor for the user Uₖⱼ. sₖⱼ∈CN (0,1) represents a corresponding modulated data symbol, which is independent of k. Therefore, a signal received at the user Uₖⱼ is as follows:

$${y}_{kj} = {\overline{h}}_{kj} {f}_{k} \sqrt{{p}_{kj} {s}_{kj}} + {\overline{h}}_{kj} {f}_{k} {\sum }_{i ∈ \{ {J}_{k} / j \}} \sqrt{{p}_{ki} {s}_{ki}} + {\overline{h}}_{kj} {f}_{\overline{k}} {\sum }_{i ∈ {J}_{\overline{k}}} \sqrt{{p}_{\overline{k} i}} {s}_{\overline{k} i} + {g}_{kj}^{H} {Θ}_{k} {n}_{s} + {n}_{kj} ,$$

If k=t, k̅=r. If k=r, k̅=t. nₛ˜CN (0,σₛ²I_{M}) represents amplified noise introduced at the MF-RIS with noise power σₛ² per unit. nₖⱼ˜CN (0,σᵤ²) represents AWGN at the user Uₖⱼ with noise power of σᵤ². h̅ₖⱼ=hₖⱼ^{H}+gₖⱼ^{H}ΘₖH represents a combined channel vector from the BS to the user Uₖⱼ.

According to a NOMA protocol, all users cancel interference through serial interference cancellation (SIC). It is assumed that equivalent combined channel gains of users in the space k in ascending order are expressed as follows:

$$\frac{{\vert {\overline{h}}_{kj} {f}_{k} \vert}^{2}}{{\vert {\overline{h}}_{kj} {f}_{\overline{k}} \vert}^{2} + {\vert {g}_{kj}^{H} {Θ}_{k} {n}_{s} \vert}^{2} + {σ}_{u}^{2}} \leq \frac{{\vert {\overline{h}}_{kl} {f}_{k} \vert}^{2}}{{\vert {\overline{h}}_{kl} {f}_{\overline{k}} \vert}^{2} + {\vert {g}_{kl}^{H} {Θ}_{k} {n}_{s} \vert}^{2} + {σ}_{u}^{2}} , ∀ k ∈ K , ∀ j ∈ {J}_{k} , ∀ l ∈ {L}_{k} ,$$

Lₖ={j, j+1, . . . , Jₖ}. Therefore, for any users Uₖⱼ and Uₖₗ satisfying j≤l, an achievable rate at which the user Uₖₗ decodes an expected signal of the user Uₖⱼ is expressed as follows:

$${R}_{l \to j}^{k} = {log}_{2} ( \frac{{\vert {\overline{h}}_{kl} {f}_{k} \vert}^{2} {p}_{kj}}{{\vert {\overline{h}}_{kl} {f}_{k} \vert}^{2} {P}_{kj} + {\vert {\overline{h}}_{kl} {f}_{\overline{k}} \vert}^{2} + {\vert {g}_{kl}^{H} {Θ}_{k} {n}_{s} \vert}^{2} + {σ}_{u}^{2}} ) ,$$

$${P}_{kj} = {\sum }_{i = j + 1}^{{J}_{k}} {p}_{ki} .$$

To ensure that SIC is successful, an achievable signal to interference plus noise ratio (SINR) when the user Uₖₗ decodes the signal of the user Uₖⱼ should not be less than an achievable SINR when the user Uₖⱼ decodes its own signal, where j≤l. Therefore, there is the following SIC decoding rate constraint:

$${R}_{l \to j}^{k} \geq {R}_{j \to j}^{k} , ∀ k ∈ K , ∀ j ∈ {J}_{k} , ∀ l ∈ {L}_{k}$$

An energy harvesting coefficient matrix of the m^{th} element is defined as

$${T}_{m} = diag ( [ {\underbrace{0 …}}_{1 to m - 1} 1 - {α}_{m} {\underbrace{… 0}}_{m + 1 to M} ] ) .$$

RF power received at the m^{th} element is expressed as follows:

$${P}_{m}^{RF} = E ( {‖ {T}_{m} ( Hs + {n}_{s} ) ‖}^{2} ) ,$$

To capture a dynamic change of RF energy conversion efficiency at different input power levels, a non-linear energy harvesting model is used in the present disclosure. Therefore, total power harvested by the m^{th} element is expressed as follows:

$${P}_{m}^{A} = \frac{{Y}_{m} - Z Ω}{1 - Ω} , {Y}_{m} = \frac{Z}{1 + {e}^{- a ( {P}_{m}^{RF} - q )}} , Ω = \frac{1}{1 + {e}^{aq}} ,$$

Yₘ is a logical function of the received RF power Pₘ^{RF}. Z≥0 is a constant that determines maximum harvested power. A constant Ω is used to ensure zero input/zero output response in the H mode. Constants a>0 and q>0 represent combined effects of a circuit sensitivity limitation and electric current leakage. To achieve self-sustainability of the MF-RIS, the following energy constraint should be satisfied:

$$2 ( {P}_{b} + {P}_{DC} ) {\sum }_{m} {α}_{m} + ( M - {\sum }_{m} {α}_{m} ) {P}_{C} + ξ {P}_{O} \leq {\sum }_{m} {P}_{m}^{A} ,$$

P_{b}, P_{DC}, P_{C} respectively represent power consumed by each phase shifter, DC bias power consumed by the amplifier circuit, and power consumed by the RF-DC conversion circuit. ξ is a reciprocal of an energy conversion coefficient. P_{O}=Σₖ(∥ΘₖHΣₖfₖ∥²+σₛ²∥ΘₖI_{M}∥²) represents output power of the MF-RIS.

An objective is to maximize the achievable SR of all users by jointly optimizing power allocation, BS transmit beamforming, the coefficient matrix, and a 3D position of the MF-RIS while maintaining self-sustainability of the MF-RIS. The following optimization problem is constructed:

$${max}_{{f}_{k} , {Θ}_{k} , w} {\sum }_{k} {\sum }_{j ∈ {J}_{k}} {R}_{j \to j}^{k}$$

$$s . t . {\sum }_{k} {‖ {f}_{k} ‖}^{2} \leq {P}_{BS}^{max} ,$$

$${Θ}_{k} ∈ {R}_{MF} , ∀ k ∈ K ,$$

$${R}_{j \to j}^{k} \geq {R}_{kj}^{min} , ∀ k ∈ K , ∀ j ∈ {J}_{k} ,$$

$$w ∈ P = \{ {[ x , y , z ]}^{T} \vert {x}_{min} \leq x \leq {x}_{max} , {y}_{min} \leq y \leq {y}_{max} , {z}_{min} \leq z \leq {z}_{max} \} ,$$

$$\frac{{\vert {\overline{h}}_{kj} {f}_{k} \vert}^{2}}{{\vert {\overline{h}}_{kj} {f}_{\overline{k}} \vert}^{2} + {\vert {g}_{kj}^{H} {Θ}_{k} {n}_{s} \vert}^{2} + {σ}_{u}^{2}} \leq \frac{{\vert {\overline{h}}_{kl} {f}_{k} \vert}^{2}}{{\vert {\overline{h}}_{kl} {f}_{\overline{k}} \vert}^{2} + {\vert {g}_{kl}^{H} {Θ}_{k} {n}_{s} \vert}^{2} + {σ}_{u}^{2}} ,$$

$$∀ k ∈ K , ∀ j ∈ {J}_{k} , ∀ l ∈ {L}_{k} ,$$

$${R}_{l \to j}^{k} \geq {R}_{j \to j}^{k} , ∀ k ∈ K , ∀ j ∈ {J}_{k} , ∀ l ∈ {L}_{k}$$

$$2 ( {P}_{b} + {P}_{DC} ) {\sum }_{m} {α}_{m} ( M - {\sum }_{m} {α}_{m} ) {P}_{C} + ξ {P}_{O} \leq {\sum }_{m} {P}_{m}^{A} ,$$

P_{BS}^{max} represents maximum transmit power of the BS. Rₖⱼ^{min} represents a minimum quality of service requirement of the user Uₖⱼ.

R_{MF}={αₘ, βₘ^{k}, θₘ^{k}|αₘ∈{0, 1}, βₘ^{k}∈[0, βₘₐₓ], Σₖβₘ^{k}≤βₘₐₓ, θₘ^{k}∈[0, 2π), ∀m, k} is a feasible coefficient set of the MF-RIS. The constraint Σₖ∥fₖ∥²≤O_{BS}^{max} limits total transmit power of the BS.

S2: The non-convex problem constructed in S1 is transformed into a more tractable form, and an AO-based algorithm is proposed to effectively find a high-performance suboptimal solution. The non-convex problem is decomposed into three subproblems: a BS transmit beamforming optimization problem, an MF-RIS coefficient design problem, and an MF-RIS deployment optimization problem.

Before the original problem is solved, the original problem is transformed into the more tractable form. First, the constraint R_{l→j}^{k}≥R_{j→j}^{k}, ∀k∈K, ∀j∈Jₖ, ∀l∈Lₖ is a necessary condition of the following inequality:

$$\frac{{\vert {\overline{h}}_{kj} {f}_{k} \vert}^{2}}{{\vert {\overline{h}}_{kj} {f}_{\overline{k}} \vert}^{2} + {\vert {g}_{kj}^{H} {Θ}_{k} {n}_{s} \vert}^{2} + {σ}_{u}^{2}} \leq \frac{{\vert {\overline{h}}_{kl} {f}_{k} \vert}^{2}}{{\vert {\overline{h}}_{kl} {f}_{\overline{k}} \vert}^{2} + {\vert {g}_{kl}^{H} {Θ}_{k} {n}_{s} \vert}^{2} + {σ}_{u}^{2}} ,$$

∀k∈K, ∀j∈Jₖ, ∀l∈Lₖ,

Specifically, according to the foregoing inequality, the equivalent combined channel gains of the users Uₖⱼ and Uₖₗ whose decoding orders j≤l satisfy the following condition:

$${\vert {\overline{h}}_{kj} {f}_{\overline{k}} \vert}^{2} ( {\vert {\overline{h}}_{kl} {f}_{\overline{k}} \vert}^{2} + {\vert {g}_{kj}^{H} {Θ}_{k} {n}_{s} \vert}^{2} + {σ}_{u}^{2} ) \leq {\vert {\overline{h}}_{kl} {f}_{\overline{k}} \vert}^{2} ( {\vert {\overline{h}}_{kj} {f}_{\overline{k}} \vert}^{2} + {\vert {g}_{kj}^{H} {Θ}_{k} {n}_{s} \vert}^{2} + {σ}_{u}^{2} )$$

Both sides of the inequality are multiplied by pₖⱼ, and pₖⱼ|h̅ₖₗf₂|²|h̅ₖⱼfₖ|² Pₖⱼ is added to both sides. An equivalent transformation is performed to obtain the following inequality:

$$\frac{{\vert {\overline{h}}_{kj} {f}_{k} \vert}^{2} {p}_{kj}}{{\vert {\overline{h}}_{kj} {f}_{\overline{k}} \vert}^{2} {P}_{kj} + {\vert {\overline{h}}_{kj} {f}_{\overline{k}} \vert}^{2} + {\vert {g}_{kj}^{H} {Θ}_{k} {n}_{s} \vert}^{2} + {σ}_{u}^{2}} \leq \frac{{\vert {\overline{h}}_{kl} {f}_{k} \vert}^{2} {p}_{kj}}{{\vert {\overline{h}}_{kl} {f}_{k} \vert}^{2} {P}_{kj} + {\vert {\overline{h}}_{kl} {f}_{\overline{k}} \vert}^{2} + {\vert {g}_{kl}^{H} {Θ}_{k} {n}_{s} \vert}^{2} + {σ}_{u}^{2}}$$

Apparently, the foregoing inequality ensures that the constraint R_{l→j}^{k}≥R_{j→j}^{k}, ∀k∈K, ∀j∈Jₖ, ∀l∈Lₖ is satisfied. Therefore, when the constraint

$$\frac{{\vert {\overline{h}}_{kj} {f}_{k} \vert}^{2}}{{\vert {\overline{h}}_{kj} {f}_{\overline{k}} \vert}^{2} + {\vert {g}_{kj}^{H} {Θ}_{k} {n}_{s} \vert}^{2} + {σ}_{u}^{2}} \leq \frac{{\vert {\overline{h}}_{kl} {f}_{k} \vert}^{2}}{{\vert {\overline{h}}_{kl} {f}_{\overline{k}} \vert}^{2} + {\vert {g}_{kl}^{H} {Θ}_{k} {n}_{s} \vert}^{2} + {σ}_{u}^{2}} ,$$

∀k∈K, ∀j∈Jₖ, ∀l∈Lₖ exists, removing the constraint R_{l→j}^{k}≥R_{j→j}^{k}, ∀k∈K, ∀j∈Jₖ, ∀l∈Lₖ does not affect optimality of the original problem. Therefore, the constraint R_{l→j}^{k}≥R_{j→j}^{k}, ∀k∈K, ∀j∈Jₖ, ∀l∈Lₖ can be removed from the original problem.

Next, to process the following highly coupled constraints:

$${\vert {\overline{h}}_{kj} {f}_{k} \vert}^{2} ( {\vert {\overline{h}}_{kl} {f}_{\overline{k}} \vert}^{2} + {\vert {g}_{kl}^{H} {Θ}_{k} {n}_{s} \vert}^{2} + {σ}_{u}^{2} ) \leq {\vert {\overline{h}}_{kl} {f}_{k} \vert}^{2} ( {\vert {\overline{h}}_{kj} {f}_{\overline{k}} \vert}^{2} + {\vert {g}_{kj}^{H} {Θ}_{k} {n}_{s} \vert}^{2} + {σ}_{u}^{2} )$$

$$2 ( {P}_{b} + {P}_{DC} ) {\sum }_{m} {α}_{m} ( M - {\sum }_{m} {α}_{m} ) {P}_{C} + ξ {P}_{O} \leq {\sum }_{m} {P}_{m}^{A}$$

A relaxation variable set Δ₀={Aₖⱼ, Bₖⱼ, Γₖⱼ, Cₘ, ζₘ} is introduced such that:

$${A}_{kj}^{- 1} = {\vert {\overline{h}}_{kl} {f}_{k} \vert}^{2} , {B}_{kj} = {\vert {\overline{h}}_{kj} {f}_{\overline{k}} \vert}^{2} + {\vert {g}_{kl}^{H} {Θ}_{k} {n}_{s} \vert}^{2} + {σ}_{u}^{2} ,$$

$${Γ}_{kj} = {A}_{kj}^{- 1} {B}_{kj}^{- 1} ,$$

$${\sum }_{m} {C}_{m}^{- 1} ( W + ξ {P}_{O} ) ( 1 - Ω ) {Z}^{- 1} + M Ω ,$$

$${ζ}_{m} = {P}_{m}^{RF}$$

With these variable definitions, the foregoing two constraints are rewritten as follows:

$${A}_{kj}^{- 1} \leq {\vert {\overline{h}}_{kl} {f}_{k} \vert}^{2} , {B}_{kj} \geq {\vert {\overline{h}}_{kj} {f}_{\overline{k}} \vert}^{2} + {\vert {g}_{kl}^{H} {Θ}_{k} {n}_{s} \vert}^{2} + {σ}_{u}^{2} ,$$

$${Γ}_{kj} \geq {A}_{kj}^{- 1} {B}_{kj}^{- 1} , ∀ k ∈ K , ∀ j ∈ {J}_{k} ,$$

$${Γ}_{kj} \leq {A}_{kj}^{- 1} {B}_{kj}^{- 1} , ∀ k ∈ K , ∀ j ∈ {J}_{k} , ∀ l ∈ {L}_{k} ,$$

$$( W + ξ {P}_{O} ) ( 1 - Ω ) {Z}^{- 1} + M Ω \leq {\sum }_{m} {C}_{m}^{- 1} ,$$

$${ζ}_{m} \leq {P}_{m}^{RF} , {C}_{m} \geq exp ( - a ( {ζ}_{m} - q ) ) + 1 , ∀ m ,$$

W=2(P_{b}+P_{DC})Σₘαₘ+(M−Σₘαₘ)P_{C}. The constraints in the foregoing second formula are non-convex because right-hand terms of the constraints are convex. The constraints are processed through SCA. Based on a fact that first-order Taylor expansion of a convex function is a global underestimation measure, lower bounds of the right-hand terms at feasible points { [symbol] , [symbol] , [symbol] } in an [symbol] ^{th} iteration are expressed as follows:

$${Γ}_{kl}^{1 b} = \frac{1}{{A}_{kl}^{( ℓ )} {B}_{kl}^{( ℓ )}} - \frac{{A}_{kl} - {A}_{kl}^{( ℓ )}}{{( {A}_{kl}^{( ℓ )} )}^{2} {B}_{kl}^{( ℓ )}} - \frac{{B}_{kl} - {B}_{kl}^{( ℓ )}}{{( {B}_{kl}^{( ℓ )} )}^{2} {A}_{kl}^{( ℓ )}} ,$$

$${C}^{1 b} = {\sum }_{m} ( \frac{2}{{C}_{m}^{( ℓ )}} - \frac{{C}_{m}}{{( {C}_{m}^{( ℓ )} )}^{2}} )$$

As a result, the original problem is equivalently transformed into the following problems:

$${max}_{{f}_{k} , {Θ}_{k} , w , {Δ}_{0}} {\sum }_{k} {\sum }_{j ∈ {J}_{k}} {R}_{j \to j}^{k}$$

$$s . t . {Γ}_{kl} \leq {Γ}_{kl}^{1 b} , ∀ k ∈ K , ∀ j ∈ {J}_{k} , ∀ l ∈ {L}_{k} ,$$

$$( W + ξ {P}_{O} ) ( 1 - Ω ) {Z}^{- 1} + M Ω \leq {C}^{1 b} ,$$

$$w ∈ P = \{ {[ x , y , z ]}^{T} \vert {x}_{min} \leq x \leq {x}_{max} , {y}_{min} \leq y \leq {y}_{max} , {z}_{min} \leq z \leq {z}_{max} \} ,$$

$${\sum }_{k} {‖ {f}_{k} ‖}^{2} \leq {P}_{BS}^{max} ,$$

$${Θ}_{k} ∈ {R}_{MF} , ∀ k ∈ K ,$$

$${R}_{j \to j}^{k} \geq {R}_{kj}^{min} , ∀ k ∈ K , ∀ j ∈ {J}_{k} ,$$

$${A}_{kj}^{- 1} \leq {\vert {\overline{h}}_{kl} {f}_{k} \vert}^{2} , {B}_{kj} \geq {\vert {\overline{h}}_{kj} {f}_{\overline{k}} \vert}^{2} + {\vert {g}_{kl}^{H} {Θ}_{k} {n}_{s} \vert}^{2} + {σ}_{u}^{2} ,$$

$${Γ}_{kj} \geq {A}_{kj}^{- 1} {B}_{kj}^{- 1} , ∀ k ∈ K , ∀ j ∈ {J}_{k} ,$$

$${ζ}_{m} \leq {P}_{m}^{RF} , {C}_{m} \geq exp ( - a ( {ζ}_{m} - q ) ) + 1 , ∀ m ,$$

Then, the three subproblems are solved one by one.

S3: For the BS transmit beamforming optimization problem in S2, auxiliary variables are introduced and the BS transmit beamforming optimization problem is solved through an SROCR method.

First, for the BS transmit beamforming optimization problem, given {Θₖ, w}, an objective is to solve the transmit beamforming vector fₖ. Due to the non-concave objective function

$${max}_{{f}_{k} , {Θ}_{k} , w} {\sum }_{k} {\sum }_{j ∈ {J}_{k}} {R}_{j \to j}^{k}$$

and the non-convex constraint R_{j→j}^{k}≥Rₖⱼ^{min}, ∀k∈K, ∀j∈Jₖ, the original problem is still difficult to be directly solved. In view of this, auxiliary variables Qₖⱼ and Cₖⱼ are introduced, where Qₖⱼ=R_{j→j}^{k} and Cₖⱼ−|h̅ₖⱼfₖ|² Pₖⱼ+Bₖⱼ. The objective function

$${max}_{{f}_{k} , {Θ}_{k} , w} {\sum }_{k} {\sum }_{j ∈ {J}_{k}} {R}_{j \to j}^{k}$$

is transformed into:

$${\sum }_{k} {\sum }_{j ∈ {J}_{k}} {R}_{j \to j}^{k} = {\sum }_{k} {\sum }_{j ∈ {J}_{k}} {Q}_{kj}$$

In addition, the following new constraints are obtained:

$${C}_{kj} \geq {\vert {h}_{kj} {f}_{k} \vert}^{2} {P}_{kj} + {B}_{kj} ,$$

$${Q}_{kj} \leq {log}_{2} ( 1 + {p}_{kj} {A}_{kj}^{- 1} {C}_{kj}^{- 1} ) ,$$

$${Q}_{kj} \geq {R}_{kj}^{min}$$

The following non-convex constraint is processed through SCA:

$${Q}_{kj} \leq {log}_{2} ( 1 + {p}_{kj} {A}_{kj}^{- 1} {C}_{kj}^{- 1} )$$

Specifically, in the [symbol] ^{th} iteration, a lower bound of a right-hand term of the constraint is expressed as follows:

$${R}_{kj}^{Ib} = {log}_{2} ( 1 + \frac{{p}_{kj}}{{A}_{kj}^{( ℓ )} {C}_{kj}^{( ℓ )}} ) - \frac{{p}_{kj} ( {log}_{2} e ) ( {A}_{kj} - {A}_{kj}^{( ℓ )} )}{{p}_{kj} {A}_{kj}^{( ℓ )} + {( {A}_{kj}^{( ℓ )} )}^{2} {C}_{kj}^{( ℓ )}} - \frac{{p}_{kj} ( {log}_{2} e ) ( {C}_{kj} - {C}_{kj}^{( ℓ )} )}{{p}_{kj} {C}_{kj}^{( ℓ )} + {( {C}_{kj}^{( ℓ )} )}^{2} {A}_{kj}^{( ℓ )}}$$

Next, H̅ₖⱼ= [symbol] and Fₖ=fₖfₖ^{H} are defined. Fₖ±0 and rank(Fₖ)=1. Then, the transmit beamforming vector is optimized by solving the following problem:

$${max}_{{F}_{k} , {Δ}_{1}} {\sum }_{k} {\sum }_{j ∈ {J}_{k}} {Q}_{kj}$$

$$s . t . rank ( {F}_{k} ) = 1 , ∀ k ,$$

$${\sum }_{k} Tr ( {F}_{k} ) \leq {P}_{B S}^{max} , {F}_{k} \pm 0 , ∀ k ,$$

$${A}_{kj}^{- 1} \leq Tr ( {\overline{H}}_{kj} , {F}_{k} ) , {B}_{kj} , \geq Tr ( {\overline{H}}_{kj} {F}_{\overline{k}} ) + {\vert {g}_{kj}^{H} {Θ}_{k} {n}_{s} \vert}^{2} + {σ}_{u}^{2} , ∀ k ∈ K , ∀ j ∈ {J}_{k} ,$$

$${C}_{kj} \geq Tr ( {\overline{H}}_{kj} {F}_{k} ) {P}_{kj} + {B}_{kj} , ∀ k ∈ K , ∀ j ∈ {J}_{k} ,$$

$${Γ}_{kj} \geq {A}_{kj}^{- 1} {B}_{kj}^{- 1} , {Γ}_{kj} \leq {Γ}_{kl}^{lb} , {Q}_{kj} \leq {R}_{kj}^{lb} , {Q}_{kj} \geq {R}_{kj}^{min} , ∀ k ∈ K , ∀ j ∈ {J}_{k} , ∀ l ∈ {L}_{k} ,$$

$${C}_{m} \geq exp ( - a ( {ζ}_{m} - q ) ) + 1 , ∀ m ,$$

$$\overline{W} \geq {\sum }_{k} Tr ( {Θ}_{k} ( H ( {\sum }_{k} {F}_{k} ) {H}^{H} + {σ}_{s}^{2} {I}_{M} ) {Θ}_{k}^{H} ) ,$$

$${ζ}_{m} \leq Tr ( {T}_{m} H ( {\sum }_{k} {F}_{k} ) {H}^{H} {T}_{m}^{H} ) + {σ}_{s}^{2} ( 1 - {α}_{m} ) ∀ m ,$$

An auxiliary variable set Δ₁={Aₖⱼ, Bₖⱼ, Cₖⱼ, Qₖⱼ, Γₖⱼ, Cₘ, ζₘ} and

$$\overline{W} = \frac{( {Cb}^{l b} - MΩ ) Z}{( 1 - Ω ) ξ} - \frac{W}{ξ}$$

are used. The main difficulty in solving the foregoing problem lies in the rank-one constraint rank(Fₖ)=1, ∀k. The constraint is processed through the SROCR method. A basic idea of the SROCR method is to gradually relax the rank-one constraint to find a feasible rank-one solution.

Specifically, wₖ^{(l-1)}∈[0, 1] is defined as a trace ratio parameter of Fₖ in a ( [symbol] −1)^{th} iteration. The rank-one constraint rank(Fₖ)=1, ∀k in the [symbol] ^{th} iteration may be replaced by the following linear constraint:

$${( {f}_{k}^{e , ( ℓ - 1 )} )}^{H} {F}_{k}^{( ℓ )} {f}_{k}^{e , ( ℓ - 1 )} \geq {w}_{k}^{( ℓ - 1 )} Tr ( {F}_{k}^{( ℓ )} ) , ∀ k ,$$

[symbol] is an eigenvector corresponding to a maximum eigenvalue of [symbol] . [symbol] is a solution of given [symbol] in the ( [symbol] −1)^{th} iteration. Therefore, the problem is transformed into:

$${max}_{{F}_{k} , {Δ}_{1}} {\sum }_{k} {\sum }_{j ∈ {J}_{k}} {Q}_{kj}$$

$$s . t {\sum }_{k} Tr ( {F}_{k} ) \leq {P}_{B S}^{max} , {F}_{k} \pm 0 , ∀ k ,$$

$${A}_{kj}^{- 1} \leq Tr ( {\overline{H}}_{kj} {F}_{k} ) , {B}_{kj} \geq Tr ( {\overline{H}}_{kj} {F}_{\overline{k}} ) + {\vert {g}_{kj}^{H} {Θ}_{k} {n}_{s} \vert}^{2} + {σ}_{u}^{2} , ∀ k ∈ K , ∀ j ∈ {J}_{k} ,$$

$${C}_{kj} \geq Tr ( {\overline{H}}_{kj} {F}_{k} ) {P}_{kj} + {B}_{kj} , ∀ k ∈ K , ∀ j ∈ {J}_{k} ,$$

$${Γ}_{kj} \geq {A}_{kj}^{- 1} {B}_{kj}^{- 1} , {Γ}_{kj} \leq {Γ}_{kl}^{lb} , {Q}_{kj} \leq {R}_{kj}^{lb} , {Q}_{kj} \leq {R}_{kj}^{min} , ∀ k ∈ K , ∀ j ∈ {J}_{k} , ∀ l ∈ {L}_{k} ,$$

$${C}_{m} \geq exp ( - a ( {ζ}_{m} - q ) ) + 1 , ∀ m ,$$

$$\overline{W} \geq {\sum }_{k} Tr ( {Θ}_{k} ( H ( {\sum }_{k} {F}_{k} ) {H}^{H} + {σ}_{s}^{2} {I}_{M} ) {Θ}_{k}^{H} ) ,$$

$${ζ}_{m} \leq Tr ( {T}_{m} H ( {\sum }_{k} {F}_{k} ) {H}^{H} {T}_{m}^{H} ) + {σ}_{s}^{2} ( 1 - {α}_{m} ) ∀ m ,$$

$${( {f}_{k}^{e , ( ℓ - 1 )} )}^{H} {F}_{k}^{( ℓ )} {f}_{k}^{e , ( ℓ - 1 )} \geq {w}_{k}^{( ℓ - 1 )} Tr ( {F}_{k}^{( ℓ )} ) , ∀ k ,$$

The problem is an SDP problem and can be effectively solved through CVX. The rank-one solution is gradually approached by iteratively increasing [symbol] from 0 to 1. The following describes an iterative algorithm for solving the problem. After the problem is solved, Cholesky decomposition is performed on Fₖ to obtain a solution of fₖ, that is, [symbol] =fₖfₖ^{H}.

The algorithm for solving the problem through the SROCR method includes: Initialize feasible points {Fₖ⁽⁰⁾, wₖ⁽⁰⁾} and a step δ₁⁽⁰⁾. Set an iteration index [symbol] ₁=0. Repeat the following steps until a stop criterion is satisfied: If the foregoing SDP problem is solvable, solve the problem to update [symbol] , and update [symbol] = [symbol] ; otherwise, update

$${δ}_{1}^{( {ℓ}_{1} + 1 )} = \frac{{δ}_{1}^{( {ℓ}_{1} )}}{2} .$$

### Update

$${w}_{k}^{( {ℓ}_{1} + 1 )} = min ( 1 , \frac{{λ}_{max} ( {F}_{k}^{( {ℓ}_{1} + 1 )} )}{Tr ( {F}_{k}^{( {ℓ}_{1} + 1 )} )} + {δ}_{1}^{( {ℓ}_{1} + 1 )} )$$

and [symbol] ₁= [symbol] ₁+1, and end the current iteration.

S4: For the MF-RIS coefficient design problem in S2, an auxiliary variable is introduced, a non-convex objective function is replaced by its CUB, an equality constraint is processed through a penalty function method, and the coefficient of the MF-RIS is designed.

For any given {fₖ, w}, vₖ=[α₁\sqrt{β₁^{k}} e^{jθ}^{₁}^{^{k}}, α₂\sqrt{β₂^{k}} e^{jθ}^{₂}^{^{k}}, . . . , α_{M}\sqrt{β_{M}^{k}} e^{jθ}^{_{M}}^{^{k}}]^{H} is used to represent \tilde{H}ₖⱼ=[diag(gₖⱼ^{H})H; hₖⱼ^{H}], and uₖ=[vxₖ; 1]. Uₖ=uₖuₖ^{H} is further defined. Uₖ±0, rank(Uₖ)=1 and [Uₖ]_{m,m}=αₘ²βₘ^{k}, [Uₖ]_{M+1, M+1}=1. The following equation holds:

$${\vert {\overline{h}}_{kj} {f}_{kj} \vert}^{2} = {\vert ( {h}_{kj}^{H} + {g}_{kj}^{H} {Θ}_{k} H ) {f}_{k} \vert}^{2} = Tr ( {\tilde{H}}_{kj} {F}_{k} {\tilde{H}}_{kj}^{H} {U}_{k} )$$

Similarly, the following equations are obtained:

$$\vert {g}_{kj}^{H} {Θ}_{k} {n}_{s} {\vert}^{2} = Tr ( {\tilde{G}}_{kj} {U}_{k} ) and$$

$${P}_{O} = {\sum }_{k} Tr ( \tilde{H} {U}_{k} )$$

$$where$$

$${\tilde{G}}_{kj} = {\tilde{g}}_{kj} {\tilde{g}}_{kj}^{H} , \tilde{H} = \tilde{h} {\tilde{h}}^{H} + {σ}_{s}^{2} {\tilde{I}}_{M} {\tilde{I}}_{M}^{H}$$

$${\tilde{g}}_{kj} = [ diag ( {g}_{kj}^{H} ) {n}_{s} ; 0 ] , \tilde{h} = [ Hs ; 0 ] , {\tilde{I}}_{M} = [ {I}_{M} ; {0}_{1 \times M} ]$$

Then, the following constraints are rewritten:

$${A}_{kj}^{- 1} \leq Tr ( {\overline{H}}_{kj} , {F}_{k} ) , {B}_{kj} \geq Tr ( {\overline{H}}_{kj} {F}_{\overline{k}} ) + {\vert {g}_{kj}^{H} {Θ}_{k} {n}_{s} \vert}^{2} + {σ}_{u}^{2} , ∀ k ∈ K , ∀ j ∈ {J}_{k} ,$$

$${C}_{kj} \geq Tr ( {\overline{H}}_{kj} {F}_{k} ) {P}_{kj} + {B}_{kj} , ∀ k ∈ K , ∀ j ∈ {J}_{k} ,$$

$$\overline{W} \geq {\sum }_{k} Tr ( {Θ}_{k} ( H ( {\sum }_{k} {F}_{k} ) {H}^{H} + {σ}_{s}^{2} {I}_{M} ) {Θ}_{k}^{H} ) ,$$

The foregoing constraints are rewritten as:

$${A}_{kj}^{- 1} \leq Tr ( {\tilde{H}}_{kj} {F}_{k} {\tilde{H}}_{kj}^{H} {U}_{k} ) , {B}_{kj} \geq Tr ( ( {\tilde{H}}_{kj} {F}_{\overline{k}} {\tilde{H}}_{kj}^{H} + {\tilde{G}}_{kj} ) {U}_{k} ) + {σ}_{u}^{2} ,$$

$${C}_{kj} \geq Tr ( {\tilde{H}}_{kj} {F}_{k} {\tilde{H}}_{kj}^{H} {U}_{k} ) {P}_{kj} + {B}_{kj} , \overline{W} \geq {\sum }_{k} Tr ( \tilde{H} {U}_{k} )$$

Therefore, the MF-RIS coefficient design problem is simplified to:

$${max}_{{U}_{k} , {Δ}_{1}} {\sum }_{k} {\sum }_{j ∈ {J}_{k}} {Q}_{kj}$$

$$s . t . {U}_{k} \pm 0 , {[ {U}_{k} ]}_{M + 1 , M + 1} = 1 , ∀ k ,$$

$${[ {U}_{k} ]}_{m , m} = {α}_{m}^{2} {β}_{m}^{k} , ∀ m , k ,$$

$$rank ( {U}_{k} ) = 1 , ∀ k ,$$

$${α}_{m} ∈ \{ 0 , 1 \} , ∀ m ,$$

$${β}_{m}^{k} ∈ [ 0 , {β}_{max} ] , {\sum }_{k} {β}_{m}^{k} \leq {β}_{max} , ∀ m , k ,$$

$${Γ}_{kj} \geq {A}_{kj}^{- 1} {B}_{kj}^{- 1} , {Γ}_{kj} \leq {Γ}_{kl}^{l b} , {Q}_{kj} , \leq {R}_{kj}^{l b} , {Q}_{kj} \geq {R}_{kj}^{min} , ∀ k , ∈ K , ∀ j ∈ {J}_{k} , ∀ l ∈ {L}_{k} ,$$

$${C}_{m} \geq exp ( - a ( {ζ}_{m} - q ) ) + 1 , ∀ m ,$$

$${ζ}_{m} \leq Tr ( {T}_{m} H ( {\sum }_{k} {F}_{k} ) {H}^{H} {T}_{m}^{H} ) + {σ}_{s}^{2} ( 1 - {α}_{m} ) , ∀ m ,$$

$${A}_{kj}^{- 1} \leq Tr ( {\tilde{H}}_{kj} {F}_{k} {\tilde{H}}_{kj}^{H} {U}_{k} ) , {B}_{kj} \geq Tr ( ( {\tilde{H}}_{kj} {F}_{\overline{k}} {\tilde{H}}_{kj}^{H} + {\tilde{G}}_{kj} ) {U}_{k} ) + {σ}_{u}^{2} ,$$

$${C}_{kj} \leq Tr ( {\tilde{H}}_{kj} {F}_{k} {\tilde{H}}_{kj}^{H} {U}_{k} ) {P}_{kj} + {B}_{kj} , \overline{W} \geq {\sum }_{k} Tr ( \tilde{H} {U}_{k} )$$

Non-convexity of the problem is derived from the non-convex constraint [Uₖ]=αₘ²βₘ^{k}, ∀m, k, rank-one constraint rank(Uₖ)=1, ∀k, and binary constraint αₘ={0, 1}, ∀m. The foregoing shows how to process the rank-one constraint through the SROCR method. Similarly, [symbol] , [symbol] , [symbol] are defined to respectively correspond to [symbol] , [symbol] , [symbol] in the constraint ( [symbol] )^{H} [symbol] [symbol] ≥ [symbol] Tr [symbol] ), ∀k, to approximate the rank-one constraint rank(Uₖ)=1, ∀k as:

$${( {u}_{k}^{eig 〈 ℓ - 1 )} )}^{H} {U}_{k}^{〈 ℓ )} {u}_{k}^{eig 〈 ℓ - 1 )} \geq {v}_{k}^{〈 ℓ - 1 )} Tr ( {U}_{k}^{〈 ℓ )} ) , ∀ k$$

The binary constraint on αₘ is equivalently transformed into the following two continuous constraints:

$${α}_{m} - {α}_{m}^{2} \leq 0 , 0 \leq {α}_{m} \leq 1$$

However, the constraint −αₘ² is still non-convex due to the non-convex term αₘ−αₘ²≤0. The constraint is processed through SCA. Specifically, an upper bound of any feasible point { [symbol] } in [symbol] ^{th} iteration is as follows:

$${( - {α}_{m}^{2} )}^{u b} = - 2 {α}_{m}^{( ℓ )} {α}_{m} + {( {α}_{m}^{( ℓ )} )}^{2}$$

To process the highly coupled constraint [Uₖ]_{m,m}=αₘ²βₘ^{k}, ∀m,k, an auxiliary variable ηₘ^{k}+αₘ²βₘ^{k} is introduced such that the following equivalent form of [Uₖ]_{m,m}=αₘ²βₘ^{k}, ∀m,k can be obtained:

$${[ {U}_{k} ]}_{m , m} = {η}_{m}^{k} , {η}_{m}^{k} = {α}_{m}^{2} {β}_{m}^{k}$$

Next, the constraint ηₘ^{k}=αₘ²βₘ^{k} is processed through a penalty function-based method. If the constraint is directly added as a penalty term to the objective function

$${max}_{{U}_{k} , {Δ}_{1}} {\sum }_{k} {\sum }_{j ∈ {J}_{k}} {Q}_{kj ,}$$

the objective function becomes ΣₖΣ_{j∈J}_{ₖ}Qₖⱼ−ρΣₖΣₘ(αₘ²βₘ^{k}−ηₘ^{k}), where ρ>0 represents a penalty factor. The obtained objective function is non-concave due to the non-convex term αₘ²βₘ^{k}. The objective function is replaced by its CUB. A function

$$g ( {α}_{m} , {β}_{m}^{k} ) = {α}_{m}^{2} {β}_{m}^{k} , G ( {α}_{m} , {β}_{m}^{k} ) = \frac{{c}_{m}^{k}}{2} {α}_{m}^{4} + \frac{{( {β}_{m}^{k} )}^{2}}{2 {c}_{m}^{k}}$$

is defined. For cₘ^{k}>0, G(αₘ, βₘ^{k}) is a CUB of g(αₘ, βₘ^{k}). When

$${c}_{m}^{k} = \frac{{β}_{m}^{k}}{{α}_{m}^{2}} ,$$

equations g(αₘ,βₘ^{k})=G(αₘ,βₘ^{k}) and ∇g(αₘ,βₘ^{k})=∇G(αₘ, βₘ^{k}) hold, where ∇g(αₘ, βₘ^{k}) represents a gradient of g(αₘ, βₘ^{k}). Finally, the original problem is reformulated as:

$${max}_{{U}_{k} , {Δ}_{1} , {η}_{m}^{k}} {\sum }_{k} {\sum }_{j ∈ {J}_{k}} {Q}_{kj} - ρ \tilde{G} ( {α}_{m} , {β}_{m}^{k} , {η}_{m}^{k} )$$

$$s . t . 0 \leq {α}_{m} \leq 1 , {α}_{m} + {( - {α}_{m}^{2} )}^{u b} \leq 0 , ∀ m ,$$

$${[ {U}_{k} ]}_{m , m} = {η}_{m}^{k} , ∀ m , k ,$$

$${U}_{k} \pm 0 , {β}_{m}^{k} ∈ [ 0 , {β}_{max} ] , {\sum }_{k} {β}_{m}^{k} \leq {β}_{max} , ∀ m , k ,$$

$${[ {U}_{k} ]}_{M + 1 , M + 1} = 1 , ∀ k ,$$

$${Γ}_{kj} \geq {A}_{kj}^{- 1} {B}_{kj}^{- 1} , {Γ}_{kj} \leq {Γ}_{kl}^{l b} , {Q}_{kj} , \leq {R}_{kj}^{l b} , {Q}_{kj} \geq {R}_{kj}^{min} , ∀ k ∈ K , ∀ j ∈ {J}_{k} , ∀ l ∈ {L}_{k} ,$$

$${C}_{m} \geq exp ( - a ( {ζ}_{m} - q ) ) + 1 , ∀ m ,$$

$${ζ}_{m} \leq Tr ( {T}_{m} H ( {\sum }_{k} {F}_{k} ) {H}^{H} {T}_{m}^{H} ) + {σ}_{s}^{2} ( 1 - {α}_{m} ) ∀ m ,$$

$${A}_{kj}^{- 1} \leq Tr ( {\tilde{H}}_{kj} {F}_{k} {\tilde{H}}_{kj}^{H} {U}_{k} ) , {B}_{kj} \geq Tr ( ( {\tilde{H}}_{kj} {F}_{\overline{k}} {\tilde{H}}_{kj}^{H} + {\tilde{G}}_{kj} ) {U}_{k} ) + {σ}_{u}^{2} ,$$

$${C}_{kj} \geq Tr ( {\tilde{H}}_{kj} {F}_{k} {\tilde{H}}_{kj}^{H} {U}_{k} ) {P}_{kj} + {B}_{kj} , \overline{W} \geq {\sum }_{k} Tr ( \tilde{H} {U}_{k} )$$

$${( {u}_{k}^{eig 〈 ℓ - 1 )} )}^{H} {U}_{k}^{〈 ℓ )} {u}_{k}^{eig , 〈 ℓ - 1 )} \geq {v}_{k}^{〈 ℓ - 1 )} Tr ( {U}_{k}^{〈 ℓ )} ) , ∀ k$$

$$\tilde{G} ( {α}_{m} , {β}_{m}^{k} , {η}_{m}^{k} ) = {\sum }_{k} {\sum }_{m} ( \frac{{c}_{m}^{k}}{2} {α}_{m}^{4} + \frac{{( {β}_{m}^{k} )}^{2}}{2 {c}_{m}^{k}} - {η}_{m}^{k} ) .$$

When ρ→∞, a solution to the foregoing problem satisfies \tilde{G}(αₘ, βₘ^{k}, ηₘ^{k})=0. The problem is an SDP problem, which can be effectively solved through CVX. The given point cₘ^{k} in the [symbol] ^{th} iteration is updated based on

$${( {c}_{m}^{k} )}^{( ℓ )} = \frac{{( {β}_{m}^{k} )}^{( ℓ - 1 )}}{{( {α}_{m}^{( ℓ - 1 )} )}^{2}} .$$

A proposed penalty-based algorithm is described in detail below.

The algorithm for solving the problem based on a penalty function includes: Initialize feasible points {Uₖ⁽⁰⁾, νₖ⁽⁰⁾}, ε>1, and a step δ₂⁽⁰⁾, and set an iteration index [symbol] ₂=0 and a maximum value of the penalty factor ρₘₐₓ. Repeat the following steps: If [symbol] ₂≤ [symbol] ₂^{max} and the original problem is solvable, solve the problem to update Uₖ^{(l}^{₂}⁺¹⁾, and update δ₂^{(l}^{₂}⁺¹⁾=δ₂^{(l}^{₂}⁾; otherwise, update

$${δ}_{2}^{( {ℓ}_{2} + 1 )} = \frac{{δ}_{2}^{( {ℓ}_{2} )}}{2} .$$

### Update

$${v}_{k}^{( {ℓ}_{2} + 1 )} = min ( 1 , \frac{{λ}_{max} ( {U}_{k}^{( {ℓ}_{2} + 1 )} )}{Tr ( {U}_{k}^{( {ℓ}_{2} + 1 )} )} + {δ}_{2}^{( {ℓ}_{2} + 1 )} ) .$$

If [symbol] =min{ε [symbol] , ρₘₐₓ}, update [symbol] ₂= [symbol] ₂+1 and end the current iteration. Otherwise, reinitialize Uₖ⁽⁰⁾ and let ε>1 and [symbol] ₂=0 until the stop criterion is satisfied.

S5: For the MF-RIS deployment optimization problem in S2, because a LOS component including a position variable of the MF-RIS is nonlinear, the position of the MF-RIS is designed through a local area optimization method, and a non-convex term is processed through SCA to transform the MF-RIS deployment optimization problem into a solvable convex problem. It can be ensured that each sub-algorithm converges to a local optimum.

Finally, the present disclosure focuses on a position optimization problem of the MF-RIS. It can be learned from the expression of the original problem that distance-independent variables L_{bs} and Lₛₖⱼ and LOS components H^{LoS} and gₖⱼ^{LoS} are all related to the position w of the MF-RIS. However:

$${{H}^{LoS} [ 1 , {e}^{- j \frac{2 π}{λ} d sin {φ}_{bs} {sin}_{bs}} , … , {e}^{- j \frac{2 π}{λ} ( {M}_{z} - 1 ) d sin {φ}_{bs} sin {\partial }_{bs}} ]}^{T} ⊗ {[ 1 , {e}^{- j \frac{2 π}{λ} d cos {φ}_{bs} sin {\partial }_{bs}} , … , {e}^{- j \frac{2 π}{λ} ( {M}_{y} - 1 ) d cos {φ}_{bs} sin {\partial }_{bs}} ]}^{T}$$

The foregoing expression reveals that the LOS components are non-linear with respect to W and are difficult to directly process. In view of this, w is designed through the local area optimization method. Specifically, w⁽ⁱ⁻¹⁾ represents a feasible position of the MF-RIS obtained in an (i−1)^{th} iteration. The position variable should satisfy the following constraint:

$$‖ w - {w}^{( i - 1 )} ‖ \leq ò ,$$

A constant ò is small such that the position of the MF-RIS in the (i−1)^{th} iteration can be used to approximate H^{LoS} and gₖⱼ^{LoS} in an i^{th} iteration. It is assumed that Ĥ⁽ⁱ⁻¹⁾ and ĝₖⱼ⁽ⁱ⁻¹⁾ are obtained in the (i−1)^{th} iteration. Then, the constraints are rewritten as:

$${A}_{kj}^{- 1} \leq {d}_{kj}^{T} {D}_{kj} {F}_{k} {D}_{kj}^{H} {d}_{kj} ,$$

$${B}_{kj} \geq {d}_{kj}^{T} {D}_{kj} {F}_{\overline{k}} {D}_{kj}^{H} {d}_{kj} + {d}_{skj}^{- {κ}_{skj}} {W}_{1}^{( i - 1 )} + {σ}_{u}^{2} ,$$

$${C}_{kj} \geq {d}_{kj}^{T} {D}_{kj} {F}_{k} {D}_{kj}^{H} {d}_{kj} {P}_{kj} + {B}_{kj} ,$$

$${d}_{b s}^{{κ}_{bs}} \geq {W}_{2}^{( i - 1 )} ,$$

$${d}_{b s}^{{κ}_{bs}} \leq {W}_{3}^{( i - 1 )} ,$$

$$where$$

$${d}_{kj} = {[ 1 , {d}_{bs}^{- \frac{{κ}_{bs}}{2}} {d}_{skj}^{- \frac{{κ}_{skj}}{2}} ]}^{T} ,$$

$${D}_{kj} = {[ {h}_{kj} , {{h}_{0} ( {\hat{H}}^{( i - 1 )} )}^{H} {Θ}_{k}^{H} {\hat{g}}_{kj}^{( i - 1 )} ]}^{H} ,$$

$${W}_{1}^{( i - 1 )} = {h}_{0} {\vert {( {\hat{g}}_{kj}^{( i - 1 )} )}^{H} {Θ}_{k} {n}_{s} \vert}^{2} ,$$

$${W}_{2}^{( i - 1 )} = \frac{{h}_{0} {\sum }_{k} Tr ( {Θ}_{k} {\hat{H}}^{( i - 1 )} ( {\sum }_{k} {F}_{k} ) {( {\hat{H}}^{( i - 1 )} )}^{H} {Θ}_{k}^{H} )}{\overline{W} - {σ}_{s}^{2} {\sum }_{k} Tr ( {Θ}_{k} {Θ}_{k}^{H} )} ,$$

$${W}_{3}^{( i - 1 )} = \frac{{h}_{0} Tr ( {T}_{m} {\hat{H}}^{( i - 1 )} ( {\sum }_{k} {F}_{k} ) {( {\hat{H}}^{( i - 1 )} )}^{H} {T}_{m}^{H} )}{{ζ}_{m} - {σ}_{s}^{2} ( 1 - {α}_{m} )}$$

Therefore, given {fₖ, Θₖ}, the problem is simplified to:

$${max}_{w , {Δ}_{1}} {\sum }_{k} {\sum }_{j ∈ {J}_{k}} {Q}_{kj}$$

$$s . t .$$

$$w ∈ P = \{ {[ x , y , z ]}^{T} \vert {x}_{m i n} \leq x \leq {x}_{ma x} , {y}_{m i n} \leq y \leq {y}_{ma x} , {z}_{m i n} \leq z \leq {z}_{ma x} \} ,$$

$${Γ}_{kj} \geq {A}_{kj}^{- 1} {B}_{kj}^{- 1} ,$$

$${Γ}_{kj} \leq {Γ}_{kl}^{l b} ,$$

$${Q}_{kj} \leq {R}_{kj}^{l b} ,$$

$${Q}_{kj} \geq {R}_{kj}^{m i n} ,$$

$$∀ k ∈ K ,$$

$$∀ j ∈ {J}_{k} ,$$

$$∀ l ∈ {L}_{k} ,$$

$${C}_{m} \geq exp ( - a ( {ζ}_{m} - q ) ) + 1 ,$$

$$∀ m ,$$

$$‖ w - {w}^{( i - 1 )} ‖ \leq ò ,$$

$${A}_{kj}^{- 1} \leq {d}_{kj}^{T} {D}_{kj} {F}_{k} {D}_{kj}^{H} {d}_{kj} ,$$

$${B}_{kj} \geq {d}_{kj}^{T} {D}_{kj} {F}_{\overline{k}} {D}_{kj}^{H} {d}_{kj} + {d}_{skj}^{- {κ}_{skj}} {W}_{1}^{( i - 1 )} + {σ}_{u}^{2} ,$$

$${C}_{kj} \geq {d}_{kj}^{T} {D}_{kj} {F}_{k} {D}_{kj}^{H} {d}_{kj} {P}_{kj} + {B}_{kj} ,$$

$$? {d}_{b s}^{{κ}_{bs}} \geq {W}_{2}^{( i - 1 )} ,$$

$${d}_{b s}^{{κ}_{bs}} \leq {W}_{3}^{( i - 1 )} ,$$

The following constraints are still non-linear and non-convex with respect to w:

$${A}_{kj}^{- 1} \leq {d}_{kj}^{T} {D}_{kj} {F}_{k} {D}_{kj}^{H} {d}_{kj} ,$$

$${B}_{kj} \geq {d}_{kj}^{T} {D}_{kj} {F}_{\overline{k}} {D}_{kj}^{H} {d}_{kj} + {d}_{skj}^{- {κ}_{skj}} {W}_{1}^{( i - 1 )} + {σ}_{u}^{2} ,$$

$${C}_{kj} \geq {d}_{kj}^{T} {D}_{kj} {F}_{k} {D}_{kj}^{H} {d}_{kj} {P}_{kj} + {B}_{kj} ,$$

$${d}_{bs}^{{κ}_{bs}} \geq {W}_{2}^{( i - 1 )} ,$$

$${d}_{bs}^{{κ}_{bs}} \leq {W}_{3}^{( i - 1 )} ,$$

The foregoing constraints are still non-linear and non-convex with respect to w. To solve this problem, an auxiliary variable set is introduced to replace complex terms, and a non-convex part is approximated through SCA. Specifically, a relaxation variable set Δ₂={t, tₖⱼ, t̅ₖⱼ, eₖⱼ, ν, ν̅, r^{kj}, r̅ₖⱼ, sₖⱼ} is introduced and d̅ₖⱼ=[1, t̅ₖⱼ]^{T} is defined to linearly approximate the constraints as:

$${\overline{t}}_{kj} \leq {tt}_{kj} ,$$

$${\overline{r}}_{kj} \geq {\overline{d}}_{kj}^{T} {\hat{H}}_{kj} {F}_{k} {\hat{H}}_{kj}^{H} {\overline{d}}_{kj} ,$$

$${s}_{kj} \geq {\overline{d}}_{kj}^{T} {\hat{H}}_{kj} {F}_{\overline{k}} {\hat{H}}_{kj}^{H} {\overline{d}}_{kj} ,$$

$${A}_{kj}^{- 1} \leq {r}_{kj} ,$$

$${B}_{kj} \geq {s}_{kj} + {e}_{kj} {W}_{1}^{( i - 1 )} + {σ}_{u}^{2} ,$$

$${C}_{kj} \geq {\overline{r}}_{kj} {P}_{kj} + {B}_{kj} ,$$

$$v \geq {W}_{2}^{( i - 1 )} ,$$

$$\overline{v} \leq {W}_{3}^{( i - 1 )} ,$$

$${r}_{kj} \leq - {( {\overline{d}}_{kj}^{( ℓ )} )}^{T} {\hat{H}}_{kj} {F}_{k} {\hat{H}}_{kj}^{H} {\overline{d}}_{kj}^{( ℓ )} + 2 ℛ ( {( {\overline{d}}_{k}^{( ℓ )} )}^{T} {\hat{H}}_{kj} {F}_{k} {\hat{H}}_{kj}^{H} {\overline{d}}_{kj} ) ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {t}^{- \frac{4}{{κ}_{bs}}} )}^{ub} \leq 0 ,$$

$${x}^{2} + {x}_{kj}^{2} + {y}^{2} + {y}_{kj}^{2} + {z}^{2} - 2 {x}_{kj} x - 2 {y}_{kj} y + {( - {t}_{kj}^{- \frac{4}{{κ}_{skj}}} )}^{u b} \leq 0 ,$$

$${( - {x}^{2} )}^{ub} - {x}_{kj}^{2} + {( - {y}^{2} )}^{ub} - {y}_{kj}^{2} + {( - {z}^{2} )}^{ub} + 2 {x}_{kj} x + 2 {y}_{kj} y + {( {e}_{kj} )}^{- \frac{2}{{κ}_{skj}}} \leq 0 ,$$

$${( - {x}^{2} )}^{ub} - {x}_{b}^{2} + {( - {y}^{2} )}^{ub} - {y}_{b}^{2} + {( - {z}^{2} )}^{ub} - {z}_{b}^{2} + 2 {x}_{b} x + 2 {y}_{b} y + 2 {z}_{b} z + {( {v}^{\frac{2}{{κ}_{bs}}} )}^{ub} \leq 0 ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {\overline{v}}^{\frac{2}{{κ}_{bs}}} )}^{u b} \leq 0 ,$$

$${( - {t}^{- \frac{4}{{κ}_{bs}}} )}^{u b} = - {( {t}^{( ℓ )} )}^{- \frac{4}{{κ}_{bs}}} + \frac{4}{{κ}_{bs}} {( {t}^{( ℓ )} )}^{- \frac{4}{{κ}_{bs}} - 1} ( t - {t}^{( ℓ )} ) ,$$

$${( - {t}_{kj}^{- \frac{4}{{κ}_{skj}}} )}^{u b} = - {( {t}_{kj}^{( ℓ )} )}^{- \frac{4}{{κ}_{skj}}} + \frac{4}{{κ}_{skj}} {( {t}_{kj}^{( ℓ )} )}^{- \frac{4}{{κ}_{skj}} - 1} ( {t}_{kj} - {t}_{kj}^{( ℓ )} ) ,$$

$${( {v}^{\frac{2}{{κ}_{bs}}} )}^{u b} = {( {v}^{( ℓ )} )}^{\frac{2}{{κ}_{bs}}} + \frac{4}{{κ}_{bs}} {( {v}^{( ℓ )} )}^{\frac{2}{{κ}_{bs}} - 1} ( v - {v}^{( ℓ )} ) ,$$

$${( - {x}^{2} )}^{ub} = {( {x}^{( ℓ )} )}^{2} - 2 {x}^{( ℓ )} x ,$$

$${( - {y}^{2} )}^{ub} = {( {y}^{( ℓ )} )}^{2} - 2 {y}^{( ℓ )} y ,$$

$${( - {z}^{2} )}^{ub} = {( {z}^{( ℓ )} )}^{2} - 2 {z}^{( ℓ )} z ,$$

{ [symbol] , [symbol] , [symbol] , [symbol] , [symbol] , [symbol] , [symbol] } are feasible points obtained in the [symbol] ^{th} iteration.

A proof of the foregoing formula is as follows:

The relaxation variable set Δ₂={t, tₖⱼ, t̅ₖⱼ, eₖⱼ, ν, ν̅, rₖⱼ, r̅ₖⱼ, sₖⱼ} is defined as:

$$t = {d}_{bs}^{\frac{{κ}_{bs}}{2}} ,$$

$${t}_{kj} = {d}_{skj}^{\frac{{κ}_{skj}}{2}} ,$$

$${\overline{t}}_{kj} = {tt}_{kj} ,$$

$${e}_{kj} = {d}_{skj}^{- {κ}_{skj}} ,$$

$$v = \overline{v} = {d}_{b s}^{{κ}_{bs}} ,$$

$${r}_{kj} = {\overline{r}}_{kj} = {\overline{d}}_{kj}^{T} {\hat{H}}_{kj} {F}_{k} {\hat{H}}_{kj}^{H} {\overline{d}}_{kj} ,$$

$${s}_{kj} = {\overline{d}}_{kj}^{T} {\hat{H}}_{kj} {F}_{\overline{k}} {\hat{H}}_{kj}^{H} {\overline{d}}_{kj}$$

Then, the following constraints are rewritten:

$${A}_{kj}^{- 1} \leq {d}_{kj}^{T} {D}_{kj} {F}_{k} {D}_{kj}^{H} {d}_{kj} ,$$

$${B}_{kj} \geq {d}_{kj}^{T} {D}_{kj} {F}_{\overline{k}} {D}_{kj}^{H} {d}_{kj} + {d}_{skj}^{- {κ}_{skj}} {W}_{1}^{( i - 1 )} + {σ}_{u}^{2} ,$$

$${C}_{kj} \geq {d}_{kj}^{T} {D}_{kj} {F}_{k} {D}_{kj}^{H} {d}_{kj} {P}_{kj} + {B}_{kj} ,$$

$${d}_{bs}^{{κ}_{bs}} \geq {W}_{2}^{( i - 1 )} ,$$

$${d}_{bs}^{{κ}_{bs}} \leq {W}_{3}^{( i - 1 )} ,$$

The foregoing constraints are rewritten as:

$$t \leq {d}_{bs}^{- \frac{{κ}_{bs}}{2}} ,$$

$${t}_{kj} \leq {d}_{skj}^{- \frac{{κ}_{skj}}{2}} ,$$

$${e}_{kj} \geq {d}_{skj}^{{κ}_{skj}} ,$$

$$v \leq {d}_{bs}^{{κ}_{bs}} ,$$

$$\overline{v} \geq {d}_{bs}^{{κ}_{bs}} ,$$

$${r}_{kj} \leq {\overline{d}}_{kj}^{T} {\hat{H}}_{kj} {F}_{k} {\hat{H}}_{kj}^{H} {\overline{d}}_{kj} ,$$

$${\overline{t}}_{kj} \leq {tt}_{kj} ,$$

$${\overline{r}}_{kj} \geq {\overline{d}}_{kj}^{T} {\hat{H}}_{kj} {F}_{k} {\hat{H}}_{kj}^{H} {\overline{d}}_{kj} ,$$

$${s}_{kj} \geq {\overline{d}}_{kj}^{T} {\hat{H}}_{kj} {F}_{\overline{k}} {\hat{H}}_{kj}^{H} {\overline{d}}_{kj} ,$$

$${A}_{kj}^{- 1} \leq {r}_{kj} ,$$

$${B}_{kj} \geq {s}_{kj} + {e}_{kj} {W}_{1}^{( i - 1 )} + {σ}_{u}^{2} ,$$

$${C}_{kj} \geq {\overline{r}}_{kj} {P}_{kj} + {B}_{kj} ,$$

$$v \geq {W}_{2}^{( i - 1 )} ,$$

$$\overline{v} \leq {W}_{3}^{( i - 1 )} .$$

Because the constraints

$$t = {d}_{bs}^{\frac{{κ}_{b s}}{2}} ,$$

$${t}_{kj} = {d}_{skj}^{\frac{{κ}_{skj}}{2}} ,$$

$${\overline{t}}_{kj} = {tt}_{kj} ,$$

$${e}_{kj} = {d}_{skj}^{{κ}_{skj}} ,$$

$$v = \overline{v} = {d}_{bs}^{{κ}_{bs}}$$

are still non-convex, they are processed through SCA. A right-hand term of the constraint rₖⱼ≤d̅ₖⱼ^{T}ĤₖⱼFₖĤₖⱼ^{H}d̅ₖⱼ is convex with respect to d̅ₖⱼ^{T}. A lower bound of the right-hand term at the given point [symbol] is obtained through first-order Taylor expansion as follows:

$$- {( {\overline{d}}_{kj}^{( ℓ )} )}^{T} {\hat{H}}_{kj} {F}_{k} {\hat{H}}_{kj}^{H} {\overline{d}}_{kj}^{( ℓ )} + 2 ℛ ( {( {\overline{d}}_{kj}^{( ℓ )} )}^{T} {\hat{H}}_{kj} {F}_{k} {\hat{H}}_{kj}^{H} {\overline{d}}_{kj} )$$

Therefore, the constraint rₖⱼ≤d̅ₖⱼ^{T}ĤₖⱼFₖĤₖⱼ^{H}d̅ₖⱼ is rewritten as the following convex constraint:

$${r}_{kj} \leq - {( {\overline{d}}_{kj}^{( ℓ )} )}^{T} {\hat{H}}_{kj} {F}_{k} {\hat{H}}_{kj}^{H} {\overline{d}}_{kj}^{( ℓ )} + 2 ℛ ( {( {\overline{d}}_{kj}^{( ℓ )} )}^{T} {\hat{H}}_{kj} {F}_{k} {\hat{H}}_{kj}^{H} {\overline{d}}_{kj} ) ,$$

To facilitate subsequent derivation of the other constraints, they are rewritten as follows:

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {t}^{- \frac{4}{{κ}_{bs}}} \leq 0 ,$$

$${x}^{2} + {x}_{kj}^{2} + {y}^{2} + {y}_{kj}^{2} + {z}^{2} - 2 {x}_{kj} x - 2 {y}_{kj} y - {t}^{- \frac{4}{{κ}_{skj}}} \leq 0 ,$$

$$- {x}^{2} - {x}_{kj}^{2} - {y}^{2} - {y}_{kj}^{2} - {z}^{2} + 2 {x}_{kj} x - 2 {y}_{kj} y + {e}_{kj}^{- \frac{2}{{κ}_{skj}}} \leq 0 ,$$

$$- {x}^{2} - {x}_{b}^{2} - {y}^{2} - {y}_{b}^{2} - {z}^{2} - {z}_{b}^{2} + 2 {x}_{b} x + 2 {y}_{b} y + 2 {z}_{b} z + {v}^{\frac{2}{{κ}_{bs}}} \leq 0 ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z - {\overline{v}}^{\frac{2}{{κ}_{bs}}} \leq 0 ,$$

The non-convex terms

$$- {t}^{- \frac{4}{{κ}_{bs}}} , - {t}_{kj}^{- \frac{4}{{κ}_{skj}}} , {v}^{\frac{2}{{κ}_{bs}}} , - {x}^{2} , - {y}^{2} , - {z}^{2}$$

lead to non-convexity of the constraints. To solve this problem, an auxiliary variable set is introduced to replace the SCA method to obtain upper bounds of

$$- {t}^{- \frac{4}{{κ}_{b s}}} , - {t}_{kj}^{- \frac{4}{{κ}_{skj}}} , {v}^{\frac{2}{{κ}_{bs}}} , - {x}^{2} , - {y}^{2} , - {z}^{2}$$

at feasible points { [symbol] , [symbol] , [symbol] , [symbol] , [symbol] , [symbol] }.

$${( - {t}^{- \frac{4}{{κ}_{bs}}} )}^{ub} = - {( {t}^{( ℓ )} )}^{- \frac{4}{{κ}_{bs}}} + \frac{4}{{κ}_{bs}} {( {t}^{( ℓ )} )}^{- \frac{4}{{κ}_{bs}} - 1} ( t - {t}^{( ℓ )} ) ,$$

$${( - {t}_{kj}^{- \frac{4}{{κ}_{skj}}} )}^{ub} = - {( {t}_{kj}^{( ℓ )} )}^{- \frac{4}{{κ}_{skj}}} + \frac{4}{{κ}_{skj}} {( {t}_{kj}^{( ℓ )} )}^{- \frac{4}{{κ}_{skj}} - 1} ( {t}_{kj} - {t}_{kj}^{( ℓ )} ) ,$$

$${( {v}^{\frac{2}{{κ}_{bs}}} )}^{ub} = {( {v}^{( ℓ )} )}^{\frac{2}{{κ}_{bs}}} + \frac{2}{{κ}_{bs}} {( {v}^{( ℓ )} )}^{\frac{2}{{κ}_{bs}} - 1} ( v - {v}^{( ℓ )} ) ,$$

$${( - {x}^{2} )}^{ub} = {( {x}^{( ℓ )} )}^{2} - 2 {x}^{( ℓ )} x ,$$

$${( - {y}^{2} )}^{ub} = {( {y}^{( ℓ )} )}^{2} - 2 {y}^{( ℓ )} y ,$$

$${( - {z}^{2} )}^{ub} = {( {z}^{( ℓ )} )}^{2} - 2 {z}^{( ℓ )} z ,$$

Finally, the non-convex terms are replaced by their respective convex approximations to obtain the following convex constraints:

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {t}^{- \frac{4}{{κ}_{bs}}} )}^{ub} \leq 0 ,$$

$${x}^{2} + {x}_{kj}^{2} + {y}^{2} + {y}_{kj}^{2} + {z}^{2} - 2 {x}_{kj} x - 2 {y}_{kj} y + {( - {t}_{kj}^{- \frac{4}{{κ}_{skj}}} )}^{u b} \leq 0 ,$$

$${( - {x}^{2} )}^{u b} - {x}_{kj}^{2} + {( - {y}^{2} )}^{u b} - {y}_{kj}^{2} + {( - {z}^{2} )}^{u b} + 2 {x}_{kj} x + 2 {y}_{kj} y + {( {e}_{kj} )}^{- \frac{2}{{κ}_{skj}}} \leq 0 ,$$

$${( - {x}^{2} )}^{ub} - {x}_{b}^{2} + {( - {y}^{2} )}^{ub} - {y}_{b}^{2} + {( - {z}^{2} )}^{ub} - {z}_{b}^{2} + 2 {x}_{b} x + 2 {y}_{b} y + 2 {z}_{b} z + {( {v}^{\frac{2}{{κ}_{bs}}} )}^{ub} \leq 0 ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {\overline{v}}^{\frac{2}{{κ}_{bs}}} )}^{ub} \leq 0 ,$$

The proof is completed.

Next:

$${r}_{kj} \leq - {( {\overline{d}}_{kj}^{( ℓ )} )}^{T} {\hat{H}}_{kj} {F}_{k} {\hat{H}}_{kj}^{H} {\overline{d}}_{kj}^{( ℓ )} + 2 ℛ ( {( {\overline{d}}_{kj}^{( ℓ )} )}^{T} {\hat{H}}_{kj} {F}_{k} {\hat{H}}_{kj}^{H} {\overline{d}}_{kj} ) ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {t}^{- \frac{4}{{κ}_{bs}}} )}^{ub} \leq 0 ,$$

$${x}^{2} + {x}_{kj}^{2} + {y}^{2} + {y}_{kj}^{2} + {z}^{2} - 2 {x}_{kj} x - 2 {y}_{kj} y + {( - {t}_{kj}^{- \frac{4}{{κ}_{skj}}} )}^{u b} \leq 0 ,$$

$${( - {x}^{2} )}^{ub} - {x}_{kj}^{2} + {( - {y}^{2} )}^{ub} - {y}_{kj}^{2} + {( - {z}^{2} )}^{ub} + 2 {x}_{kj} x + 2 {y}_{kj} y + {( {e}_{kj} )}^{- \frac{2}{{κ}_{skj}}} \leq 0 ,$$

$${( - {x}^{2} )}^{ub} - {x}_{b}^{2} + {( - {y}^{2} )}^{ub} - {y}_{b}^{2} + {( - {z}^{2} )}^{ub} - {z}_{b}^{2} + 2 {x}_{b} x + 2 {y}_{b} y + 2 {z}_{b} z + {( {v}^{\frac{2}{{κ}_{bs}}} )}^{ub} \leq 0 ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {\overline{v}}^{\frac{2}{{κ}_{bs}}} )}^{ub} \leq 0 ,$$

The following non-convex constraints are replaced by the foregoing convex constraints:

$${A}_{kj}^{- 1} \leq {d}_{kj}^{T} {D}_{kj} {F}_{k} {D}_{kj}^{H} {d}_{kj} ,$$

$${B}_{kj} \geq {d}_{kj}^{T} {D}_{kj} {F}_{\overline{k}} {D}_{kj}^{H} {d}_{kj} + {d}_{skj}^{- {κ}_{skj}} {W}_{1}^{( i - 1 )} + {σ}_{u}^{2} ,$$

$${C}_{kj} \geq {d}_{kj}^{T} {D}_{kj} {F}_{k} {D}_{kj}^{H} {d}_{kj} {P}_{kj} + {B}_{kj} ,$$

$${d}_{b s}^{{κ}_{b s}} \geq {W}_{2}^{( i - 1 )} ,$$

$${d}_{b s}^{{κ}_{b s}} \leq {W}_{3}^{( i - 1 )} ,$$

The original problem is reformulated as the following optimization problem:

$${max}_{w , {Δ}_{1}} {\sum }_{k} {\sum }_{j ∈ {J}_{k}} {Q}_{kj}$$

$$s . t .$$

$$w ∈ P = \{ {[ x , y , z ]}^{T} \vert {x}_{m i n} \leq x \leq {x}_{ma x} , {y}_{m i n} \leq y \leq {y}_{ma x} , {z}_{m i n} \leq z \leq {z}_{m ax} \} ,$$

$${Γ}_{kj} \geq {A}_{kj}^{- 1} {B}_{kj}^{- 1} ,$$

$${Γ}_{kj} \leq {Γ}_{kl}^{l b} ,$$

$${Q}_{kj} \leq {R}_{kj}^{l b} ,$$

$${Q}_{kj} \geq {R}_{kj}^{m i n} ,$$

$$∀ k ∈ K ,$$

$$∀ j ∈ {J}_{k} ,$$

$$∀ l ∈ {L}_{k} ,$$

$${C}_{m} \geq exp ( - a ( {ζ}_{m} - q ) ) + 1 ,$$

$$∀ m ,$$

$$‖ w - {w}^{( i - 1 )} ‖ \leq ó ,$$

$${r}_{kj} \leq - {( {\overline{d}}_{kj}^{( ℓ )} )}^{T} {\hat{H}}_{kj} {F}_{k} {\hat{H}}_{kj}^{H} {\overline{d}}_{kj}^{( ℓ )} + 2 ℛ ( {( {\overline{d}}_{kj}^{( ℓ )} )}^{T} {\hat{H}}_{kj} {F}_{k} {\hat{H}}_{kj}^{H} {\overline{d}}_{kj} ) ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {t}^{- \frac{4}{{κ}_{bs}}} )}^{ub} \leq 0 ,$$

$${x}^{2} + {x}_{kj}^{2} + {y}^{2} + {y}_{kj}^{2} + {z}^{2} - 2 {x}_{kj} x - 2 {y}_{kj} y + {( - {t}_{kj}^{- \frac{4}{{κ}_{s {k}_{j}}}} )}^{u b} \leq 0 ,$$

$${( - {x}^{2} )}^{u b} - {x}_{kj}^{2} + {( - {y}^{2} )}^{u b} - {y}_{kj}^{2} + {( - {z}^{2} )}^{u b} + 2 {x}_{kj} x + 2 {y}_{kj} y + {( {e}_{kj} )}^{- \frac{2}{{κ}_{skj}}} \leq 0 ,$$

$${( - {x}^{2} )}^{ub} - {x}_{b}^{2} + {( - {y}^{2} )}^{ub} - {y}_{b}^{2} + {( - {z}^{2} )}^{ub} - {z}_{b}^{2} + 2 {x}_{b} x + 2 {y}_{b} y + 2 {z}_{b} z + {( {v}^{\frac{2}{{κ}_{bs}}} )}^{ub} \leq 0 ,$$

$${x}^{2} + {x}_{b}^{2} + {y}^{2} + {y}_{b}^{2} + {z}^{2} + {z}_{b}^{2} - 2 {x}_{b} x - 2 {y}_{b} y - 2 {z}_{b} z + {( - {\overline{v}}^{\frac{2}{{κ}_{bs}}} )}^{ub} \leq 0 ,$$

The problem is a convex problem and can be effectively solved through CVX. A proposed local area-based algorithm is described in detail below.

The algorithm for solving the problem based on a local area includes:

Initialize feasible points {w⁽⁰⁾, t⁽⁰⁾, tₖⱼ⁽⁰⁾, ν⁽⁰⁾}. Set an iteration index [symbol] ₃=0, Repeat the following steps: Solve the problem to update { [symbol] , [symbol] , [symbol] , [symbol] }, and update [symbol] ₃= [symbol] ₃+1 until a stop criterion is satisfied.

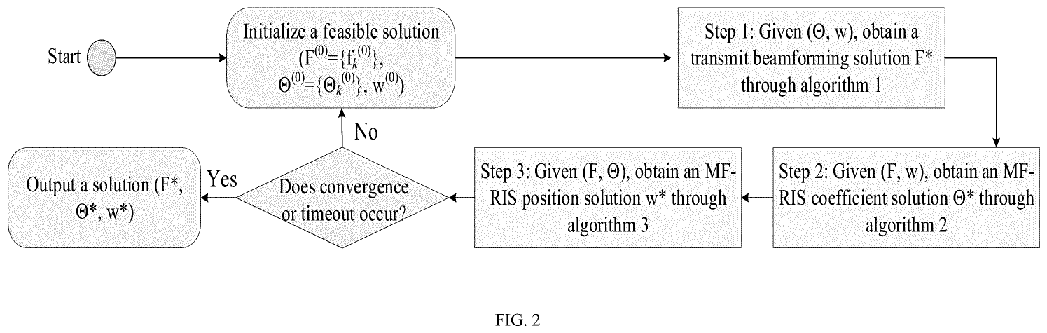

Based on the foregoing algorithms, a flowchart of an AO algorithm for solving the optimization problem is shown in FIG. 2. Because each sub-algorithm converges to its local optimum, it is ensured that the entire AO algorithm converges.

The foregoing embodiments are used only to describe the technical solutions of the present disclosure, and are not intended to limit same. Although the present disclosure is described in detail with reference to the foregoing embodiments, those of ordinary skill in the art should understand that they can still modify the technical solutions described in the foregoing embodiments, or make equivalent substitutions to some technical features therein. These modifications or substitutions do not make the essence of the corresponding technical solutions depart from the spirit and scope of the technical solutions of the embodiments of the present disclosure.

What is claimed is:

1. A multi-functional reconfigurable intelligence surface (MF-RIS) integrating signal reflection, refraction and amplification and energy harvesting, having two working modes, namely an energy harvesting mode and a signal relay mode, wherein in the signal relay mode, an incident signal is reflected and refracted through surface equivalent electrical impedance and magnetoimpedance elements, the incident signal is divided into a first part and a second part by controlling electric current and magnetic current through a microcontroller unit (MCU) chip, the first part is reflected to reflection half-space and the second part is refracted to refraction half-space, and a reflected signal and a refracted signal are amplified through an amplifier circuit; in the energy harvesting mode, radio frequency (RF) energy is obtained from the incident signal and converted into direct current (DC) power through an impedance matcher, an RF-DC conversion circuit and a capacitor, and an energy management module controls energy to be stored in an energy storage apparatus or supplied for operation of a phase shifter and the amplifier circuit; and a circuit connection is adjusted such that each element is flexibly switched between the energy harvesting mode and the signal relay mode.

2. An application method of the MF-RIS integrating signal reflection, refraction and amplification and energy harvesting according to claim 1 in a multi-user wireless network, comprising the following steps:
S1: designing operation modes and parameters, comprising base station (BS) transmit beamforming, and different components and a deployment position of the MF-RIS, and constructing a mixed integer non-linear programming non-convex optimization problem and constraints with an objective of maximizing an achievable sum rate (SR) of all users;
S2: decomposing the non-convex problem constructed in S1 into three subproblems: a BS transmit beamforming optimization problem, an MF-RIS coefficient design problem, and an MF-RIS deployment optimization problem; and
S3: performing alternating optimization (AO) on the subproblems obtained through decomposition in S2 to ensure that each sub-algorithm converges to a local optimum, which comprises: for the BS transmit beamforming optimization problem, introducing auxiliary variables and solving the BS transmit beamforming optimization problem through a sequential rank-one constraint relaxation (SROCR) method; for the MF-RIS coefficient design problem, introducing an auxiliary variable, replacing a non-convex objective function with a convex upper bound (CUB) of the non-convex objective function, processing an equality constraint through a penalty function method, and designing a coefficient of the MF-RIS; and for the MF-RIS deployment optimization problem, designing the position of the MF-RIS through a local area optimization method, and processing a non-convex term through successive convex approximation (SCA) to transform the MF-RIS deployment optimization problem into a solvable convex problem.

3. The application method of the MF-RIS integrating signal reflection, refraction and amplification and energy harvesting in the multi-user wireless network according to claim 2, wherein the optimization problem and the constraints in S1 are as follows:
$${max}_{{f}_{k} , {Θ}_{k} , w} {\sum }_{k} {\sum }_{j ∈ {J}_{k}} {R}_{j \to j}^{k}$$
$$s . t .$$
$${\sum }_{k} {‖ {f}_{k} ‖}^{2} \leq {P}_{B S}^{m ax} ,$$
$${Θ}_{k} ∈ {R}_{MF} ,$$
$$∀ k ∈ K ,$$
$${R}_{j \to j}^{k} \geq {R}_{kj}^{m i n} ,$$
$$∀ k ∈ K ,$$
$$∀ j ∈ {J}_{k} ,$$
$$w ∈ P = \{ {[ x , y , z ]}^{T} \vert {x}_{m i n} \leq x \leq {x}_{ma x} , {y}_{m i n} \leq y \leq {y}_{ma x} , {z}_{m i n} \leq z \leq {z}_{ma x} \} ,$$
$$\frac{{\vert {\overline{h}}_{kj} {f}_{k} \vert}^{2}}{{\vert {\overline{h}}_{kj} {f}_{\overline{k}} \vert}^{2} + {\vert {g}_{kj}^{H} {Θ}_{k} {n}_{s} \vert}^{2} + {σ}_{u}^{2}} \leq \frac{{\vert {\overline{h}}_{k l} {f}_{k} \vert}^{2}}{{\vert {\overline{h}}_{k l} {f}_{\overline{k}} \vert}^{2} + {\vert {g}_{k l}^{H} {Θ}_{k} {n}_{s} \vert}^{2} + {σ}_{u}^{2}} ,$$
$$∀ k ∈ K ,$$
$$∀ j ∈ {J}_{k} ,$$
$$∀ l ∈ {L}_{k} ,$$
$${R}_{l \to j}^{k} \geq {R}_{j \to j}^{k} ,$$
$$∀ k ∈ K ,$$
$$∀ j ∈ {J}_{k} ,$$
$$∀ l ∈ {L}_{k}$$
$$2 ( {P}_{b} + {P}_{D C} ) {\sum }_{m} {α}_{m} + ( M - {\sum }_{m} {α}_{m} ) {P}_{C} + ξ {P}_{O} \leq {\sum }_{m} {P}_{m}^{A} ,$$
wherein a quantity of elements of the MF-RIS is M, a set of the elements of the MF-RIS is indexed as M={1, . . . , M}, and m is an m^{th} element in the set of the elements; a quantity of antennas is J, a space set is K={r,t}, a user set is J={1, 2, . . . , J}, j is a j^{th} element in the user set, Jₖ={1, 2, . . . , Jₖ} represents a user set in space K, Jᵣ∪Jₜ=J, and if k=t, k̅=r; if k=r, k̅=t, and a user j in the space K is indexed as Uₖⱼ; h̅ₖⱼ=hₖⱼ^{H}+gₖⱼ^{H}ΘₖH represents a combined channel vector from a BS to the user Uₖⱼ, Θₖ is the coefficient of the MF-RIS, and R_{MF} is a feasible coefficient set of the MF-RIS; R_{j→j}^{k} is an achievable rate of an expected signal of the user Uₖⱼ, Rₖⱼ^{min} represents a minimum quality of service requirement of the user Uₖⱼ, fₖ is a transmit beamforming vector of the space k, P_{BS}^{max} represents maximum transmit power of the BS, P represents a predefined deployment area of the MF-RIS, considering a three-dimensional (3D) Cartesian coordinate system, positions of the BS, the MF-RIS, and the user Uₖⱼ are respectively w_{b}=[x_{b}, y_{b}, z_{b}]^{T}, w=[x, y, z]^{T}, and wₖⱼ=[xₖⱼ, yₖⱼ, 0]^{T}, and [xₘᵢₙ, xₘₐₓ], [yₘᵢₙ, yₘₐₓ], and [zₘᵢₙ, zₘₐₓ] respectively represent candidate ranges along X, Y, and Z axes; nₛ˜CN (0,σₛ²I_{M}) represents amplified noise introduced at the MF-RIS with noise power σₛ² per unit, and nₖⱼ˜CN (0,σᵤ²) represents additive white Gaussian noise (AWGN) at the user Uₖⱼ with power σᵤ²; a constant aₘ represents impact of a circuit sensitivity limitation on the m^{th} element, and P_{b}, P_{DC}, P_{C} respectively represent power consumed by each phase shifter, DC bias power consumed by the amplifier circuit, and power consumed by the RF-DC conversion circuit; and ξ is a reciprocal of an energy conversion coefficient, and P_{O}=Σₖ(∥ΘₖHΣₖfₖ∥²+σₛ²∥ΘₖI_{M}∥²) represents output power of the MF-RIS.

4. The application method of the MF-RIS integrating signal reflection, refraction and amplification and energy harvesting in the multi-user wireless network according to claim 3, wherein decomposing the non-convex problem into the three subproblems in S2 comprises:
removing the constraint R_{l→j}^{k}≥R_{j→j}^{k}, ∀k∈K, ∀j∈Jₖ, ∀I∈Lₖ, from the non-convex problem;
introducing a relaxation variable set Δ₀={Aₖⱼ, Bₖⱼ, Γₖⱼ, Cₘ, ζₘ} such that:
$${A}_{kj}^{- 1} = {\vert {\overline{h}}_{kj} {f}_{k} \vert}^{2} ,$$
$${B}_{kj} = {\vert {\overline{h}}_{kj} {f}_{\overline{k}} \vert}^{2} + {\vert {g}_{kj}^{H} {Θ}_{k} {n}_{s} \vert}^{2} + {σ}_{u}^{2} ,$$
$${Γ}_{kj} = {A}_{kj}^{- 1} {B}_{kj}^{- 1} ,$$
$${\sum }_{m} {C}_{m}^{- 1} = ( W + ξ {P}_{O} ) ( 1 - Ω ) {Z}^{- 1} + M Ω ,$$
$${ζ}_{m} = {P}_{m}^{RF}$$
rewriting the constraints as:
$${A}_{kj}^{- 1} \leq {\vert {\overline{h}}_{kj} {f}_{k} \vert}^{2} ,$$
$${B}_{kj} \geq {\vert {\overline{h}}_{kj} {f}_{\overline{k}} \vert}^{2} + {\vert {g}_{kj}^{H} {Θ}_{k} {n}_{s} \vert}^{2} + {σ}_{u}^{2} ,$$
$${Γ}_{kj} \geq {A}_{kj}^{- 1} {B}_{kj}^{- 1} ,$$
$$∀ k ∈ K ,$$
$$∀ j ∈ {J}_{k} ,$$
$${Γ}_{kj} \leq {A}_{k l}^{- 1} {B}_{k l}^{- 1} ,$$
$$∀ k ∈ K ,$$
$$∀ j ∈ {J}_{k} ,$$
$$∀ l ∈ {L}_{k} ,$$
$$( W + ξ {P}_{O} ) ( 1 - Ω ) {Z}^{1} + M Ω \leq {\sum }_{m} {C}_{m}^{- 1} ,$$
$${ζ}_{m} \leq {P}_{m}^{RF} ,$$
$${C}_{m} \geq exp ( - a ( {ζ}_{m} - q ) ) + 1 ,$$
$$∀ m ,$$
wherein W=2(P_{b}+P_{DC})Σₘαₘ+(M−Σₘαₘ)P_{C}; and
processing the non-convex constraints in the foregoing second formula through SCA; and performing first-order Taylor expansion to obtain lower bounds of right-hand terms of Aₖₗ⁻¹Bₖₗ⁻¹ and Σₘ Cₘ⁻¹ at feasible points { [symbol] , [symbol] , [symbol] } in a [symbol] ^{th} iteration as follows:
$${Γ}_{k l}^{l b} = \frac{1}{{A}_{k l}^{( ℓ )} {B}_{k l}^{( ℓ )}} - \frac{{A}_{k l} - {A}_{k l}^{( ℓ )}}{{( {A}_{k l}^{( ℓ )} )}^{2} {B}_{k l}^{( ℓ )}} - \frac{{B}_{k l} - {B}_{k l}^{( ℓ )}}{{( {B}_{k l}^{( ℓ )} )}^{2} {A}_{k l}^{( ℓ )}} ,$$
$${C}^{l b} = {\sum }_{m} ( \frac{2}{{C}_{m}^{( ℓ )}} - \frac{{C}_{m}}{{( {C}_{m}^{( ℓ )} )}^{2}} )$$
wherein in this way, the non-convex problem is decomposed into the three subproblems: the BS transmit beamforming optimization problem, the MF-RIS coefficient design problem, and the MF-RIS deployment optimization problem.

5. The application method of the MF-RIS integrating signal reflection, refraction and amplification and energy harvesting in the multi-user wireless network according to claim 4, wherein in S3, for the BS transmit beamforming optimization problem, given {Θₖ, w}, auxiliary variables Qₖⱼ and Cₖⱼ are introduced to transform an objective function
$${max}_{{f}_{k} , {Θ}_{k} w} {\sum }_{k} {\sum }_{j ∈ {J}_{k}} {R}_{j \to j}^{k} , {Q}_{kj} = {R}_{j \to j}^{k}$$
and Cₖⱼ=|h̅ₖⱼfₖ|² Pₖⱼ+Bₖⱼ, the non-convex constraint Qₖⱼ≤log₂(1+pₖⱼAₖⱼ⁻¹Cₖⱼ⁻¹) is processed through SCA, a lower bound of a right-hand term of the non-convex constraint is obtained in the [symbol] ^{th} iteration, H̅ₖⱼ= [symbol] and Fₖ=kₖfₖ^{H} are defined, Fₖ±0 and rank(Fₖ)=1, an auxiliary variable set
$${Δ}_{1} = \{ {A}_{kj} , {B}_{kj} , {C}_{kj} , {Q}_{kj} , {Γ}_{kj} , {C}_{kj} , {ζ}_{m} \}$$
$$and$$
$$\overline{W} = \frac{( {C}^{l b} - M Ω ) Z}{( 1 - Ω ) ξ} - \frac{W}{ξ}$$
are introduced such that W̅≥Σₖ Tr(Θₖ(H(Σₖ Fₖ)H^{H}+σₛ²I_{M})Θₖ^{H}), a rank-one constraint rank(Fₖ)=1, ∀k is replaced by a linear constraint ( [symbol] )^{H} [symbol] [symbol] ≥ [symbol] Tr( [symbol] ), ∀k, through the SROCR method, [symbol] ∈[0, 1] is a trace ratio parameter of Fₖ in a ( [symbol] −1)^{th} iteration, [symbol] is an eigenvector corresponding to a maximum eigenvalue of [symbol] , [symbol] is a solution of [symbol] in the ( [symbol] −1)^{th} iteration, and the BS transmit beamforming optimization problem is transformed into a convex semidefinite programming (SDP) problem.

6. The application method of the MF-RIS integrating signal reflection, refraction and amplification and energy harvesting in the multi-user wireless network according to claim 5, wherein an algorithm for solving the convex SDP problem into which the BS transmit beamforming optimization problem is transformed comprises: initializing feasible points {Fₖ⁽⁰⁾, wₖ⁽⁰⁾} and a step δ₁⁽⁰⁾, setting an iteration index [symbol] ₁=0, and repeating the following steps until a stop criterion is satisfied: if the convex SDP problem is solvable, solving the convex SDP problem to update [symbol] , and updating [symbol] = [symbol] ; otherwise, updating
$${δ}_{1}^{( {ℓ}_{1} + 1 )} = \frac{{δ}_{1}^{( {ℓ}_{1} )}}{2} ;$$
and updating
$${w}_{k}^{( {ℓ}_{1} + 1 )} = min ( 1 , \frac{{λ}_{ma x} ( {F}_{k}^{( {ℓ}_{1} + 1 )} )}{Tr ( {F}_{k}^{( {ℓ}_{1} + 1 )} )} + {δ}_{1}^{( {ℓ}_{1} + 1 )} )$$
and [symbol] ₁= [symbol] ₁+1, and ending the current iteration.

7. The application method of the MF-RIS integrating signal reflection, refraction and amplification and energy harvesting in the multi-user wireless network according to claim 4, wherein in S3, for the MF-RIS coefficient design problem, given {fₖ, w}, Hₖⱼ=[diag(gₖⱼ^{H})], vₖ=[α₁\sqrt{β₁^{k}} e^{jθ}^{₁}^{^{k}}, α₂\sqrt{β₂^{k}} e^{jθ}^{₂}^{^{k}}, . . . , α_{M}\sqrt{β_{M}^{k}} e^{jθ}^{_{M}}^{^{k}}]^{H}, and uₖ=[vₖ; 1] are defined; and Uₖ=uₖuₖ^{H} is defined, Uₖ±0, rank(Uₖ)=1, [U]_{m,m}=αₘ²βₘ^{k}, [Uₖ]_{M+1, M+1}=1, and the following equation is obtained:
$${\vert {\overline{h}}_{kj} {f}_{kj} \vert}^{2} = {\vert ( {h}_{kj}^{H} + {g}_{kj}^{H} {Θ}_{k} H ) {f}_{k} \vert}^{2} = Tr ( {H}_{kj} {F}_{k} {H}_{kj}^{H} {U}_{k} )$$
similarly, |gₖⱼ^{H}Θₖnₛ|²=Tr(GₖⱼUₖ) and P_{O}=Σₖ Tr(HUₖ) are obtained;
the constraints on Aₖⱼ, Bₖⱼ, Cₖⱼ, W̅ are rewritten as:
$${A}_{kj}^{- 1} \leq Tr ( {\tilde{H}}_{kj} {F}_{k} {\tilde{H}}_{kj}^{H} {U}_{k} ) ,$$
$${B}_{kj} \geq Tr ( ( {\tilde{H}}_{kj} {F}_{\overline{k}} {\tilde{H}}_{kj}^{H} + {\tilde{G}}_{kj} ) {U}_{k} ) + {σ}_{u}^{2} ,$$
$${C}_{kj} \geq Tr ( {\tilde{H}}_{kj} {F}_{k} {\tilde{H}}_{kj}^{H} {U}_{k} ) {P}_{kj} + {B}_{kj ,}$$
$$\overline{W} \geq {\sum }_{k} Tr ( \tilde{H} {U}_{k} )$$
a rank-one constraint rank(Uₖ)=1, ∀k is approximated as ( [symbol] )^{H} [symbol] [symbol] ≥ [symbol] Tr [symbol] , ∀k, and a binary constraint αₘ∈{0, 1}, ∀m is equivalently transformed into αₘ−αₘ²≤0, 0≤αₘ≤1; and
the constraint αₘ−αₘ²≤0 is processed through SCA; and an auxiliary variable ηₘ^{k}=αₘ²βₘ^{k} is introduced, and a non-convex constraint [Uₖ]_{m,m}=αₘ²βₘ^{k}, ∀m,k is equivalently represented as [Uₖ]_{m,m}=ηₘ^{k}, ηₘ^{k}=αₘ²βₘ^{k}, and the equality constraint ηₘ^{k}=αₘ²βₘ^{k} is processed through a penalty function to transform the MF-RIS coefficient design problem into a penalty function method-based problem.

8. The application method of the MF-RIS integrating signal reflection, refraction and amplification and energy harvesting in the multi-user wireless network according to claim 7, wherein an algorithm for solving the penalty function method-based problem comprises: initializing feasible points {Uₖ⁽⁰⁾, νₖ⁽⁰⁾}ε>1, and a step δ₂⁽⁰⁾, and setting an iteration index [symbol] ₂2=0 and a maximum value of a penalty factor ρₘₐₓ; and repeating the following steps: if [symbol] ₂≤ [symbol] ₂^{max} and the penalty function method-based problem is solvable, solving the penalty function method-based problem to update [symbol] , and updating [symbol] = [symbol] ; otherwise, updating [symbol] = [symbol] ; updating
$${v}_{k}^{( {ℓ}_{2} + 1 )} = min ( 1 , \frac{{λ}_{ma x} ( {U}_{k}^{( {ℓ}_{2} + 1 )} )}{Tr ( {U}_{k}^{( {ℓ}_{2} + 1 )} )} + {δ}_{2}^{( {ℓ}_{2} + 1 )} ) ;$$
and if ρ⁽ [symbol] ^{₂}⁺¹⁾=min{ερ⁽ [symbol] ^{₂}⁾, ρₘₐₓ}, updating [symbol] ₂= [symbol] ₂=1 and ending the current iteration; otherwise, reinitializing Uₖ⁽⁰⁾ and letting ε>1 and [symbol] ₂=0 until a stop criterion is satisfied.

9. The application method of the MF-RIS integrating signal reflection, refraction and amplification and energy harvesting in the multi-user wireless network according to claim 4, wherein in S3, for the MF-RIS deployment optimization problem, the position w of the MF-RIS is designed through the local area optimization method, w⁽ⁱ⁻¹⁾ is defined as a position of the MF-RIS obtained in an (i−1)^{th} iteration, and a position variable satisfies a constraint ∥w−w⁽ⁱ⁻¹⁾∥≤ò; it is assumed that Ĥ⁽ⁱ⁻¹⁾ and ĝₖⱼ⁽ⁱ⁻¹⁾ are obtained in the (i−1)^{th} iteration, Ĥ⁽ⁱ⁻¹⁾ and ĝₖⱼ⁽ⁱ⁻¹⁾ are respectively an array response and small-scale fading after the (i−1)^{th} iteration from the BS to the MF-RIS and from the MF-RIS to the user Uₖⱼ, and a constraint comprising Aₖⱼ, Bₖⱼ, Cₖⱼ, d_{bs}^{κ}^{_{bs}}, d_{bs}^{κ}^{_{bs}} is re-expressed; an auxiliary variable set is introduced to replace complex terms of the constraint, and a non-convex part of the constraint is approximated through SCA; and a right-hand term of a non-convex constraint rₖⱼ≤d̅ₖⱼ^{T}ĤₖⱼFₖĤₖⱼ^{H}d̅ₖⱼ is a convex term with respect to d̅ₖⱼ^{T}, the constraint rₖⱼ≤d̅ₖⱼ^{T}ĤₖⱼFₖĤₖⱼ^{H}d̅ₖⱼ is rewritten as a convex constraint rₖⱼ≤− [symbol] )^{T}ĤₖⱼFₖĤₖⱼ^{H} [symbol] +2 [symbol] (( [symbol] )^{T}Ĥₖⱼ FₖĤₖⱼ^{H}dₖⱼ), through first-order Taylor expansion, and [symbol] is a feasible point in the [symbol] ^{th} iteration.

10. The application method of the MF-RIS integrating signal reflection, refraction and amplification and energy harvesting in the multi-user wireless network according to claim 9, wherein an algorithm for solving the local area-based problem comprises: initializing feasible points {w⁽⁰⁾, t⁽⁰⁾, tₖⱼ⁽⁰⁾, ν⁽⁰⁾} and setting an iteration index [symbol] ₃=0; and repeating the following steps: solving the problem to update { [symbol] , [symbol] , [symbol] , [symbol] }, and updating [symbol] ₃= [symbol] ₃+1 until a stop criterion is satisfied.
